(19) United States
(12) Patent Application Publication
(10) Pub. No.: US 2026/0172447 A1
(43) Pub. Date: Jun. 18, 2026

(54) REAL-TIME DETECTION OF DNS HIJACKING

(71) Applicant: Palo Alto Networks, Inc., Santa Clara, CA (US)

(72) Inventors: Janos Szurdi, Sunnyvale, CA (US); Mohammad Ghasemisharif, San Jose, CA (US); Zhanhao Chen, Sunnyvale, CA (US); Daiping Liu, Sunnyvale, CA (US); Wanjin Li, Santa Clara, CA (US); Fan Fei, Pleasanton, CA (US)

(21) Appl. No.: 18/978,866

(22) Filed: Dec. 12, 2024

(51) Int. Cl. H04L 9/40

(52) U.S. Cl. CPC H04L 63/1466

(57) ABSTRACT

The present application discloses a method, system, and computer system for detecting hijacked domains. The method includes (i) filtering a set of DNS records in real-time to filter out DNS records determined not to be associated with DNS hijacking and store an indication of a set of resultant filtered DNS records, (ii) detecting DNS hijacking records based at least in part on processing a batch of resultant filtered DNS records, and (iii) performing an active measure in response to detecting the DNS hijacking records. The set of resultant filtered DNS records are batched according to a predefined timeframe.

### BACKGROUND OF THE INVENTION

The Domain Name System (DNS) is a critical component of the internet infrastructure, translating human-readable domain names (e.g., www.example.com) into IP addresses that computers use to identify each other on the network. DNS hijacking, also known as DNS redirection, is a malicious attack in which the DNS settings are changed to redirect, for example, traffic to fraudulent websites. This can lead to severe consequences, including the theft of sensitive information, financial losses, and damage to the reputation of the targeted entities.

DNS hijacking can occur through various methods, such as stealing accounts at domain registrars, compromising DNS servers, altering DNS settings on individual computers, or exploiting vulnerabilities in network equipment. For example, once a DNS record has been hijacked, users attempting to visit a legitimate website are instead directed to a malicious site, often without their knowledge. This type of attack is particularly insidious because it can be difficult to detect.

Detecting DNS hijacking using passive DNS is challenging as a few malicious records need to be identified from hundreds of billions of DNS records. As detection is so challenging, traditional defensive methods aim at preventing DNS hijacking by fixing vulnerabilities and hardening user accounts (e.g., using two factor authentication).

### BRIEF DESCRIPTION OF THE DRAWINGS

Various embodiments of the invention are disclosed in the following detailed description and the accompanying drawings.

FIG. 1 is a block diagram of an environment for providing a security service to a network according to various embodiments.

FIG. 2 is a block diagram of a system to handle DNS requests and DNS responses according to various embodiments.

FIG. 3 is an illustration of a system for providing real-time detection of DNS hijacking records according to various embodiments.

FIG. 4 is an illustration of system for pre-filtering DNS records in connection with providing real-time detection of DNS hijacking records according to various embodiments.

FIG. 5 is an illustration of a system for providing real-time detection of DNS hijacking records according to various embodiments.

FIG. 6 is a flow diagram of a method for providing real-time detection of DNS hijacking records according to various embodiments.

FIG. 7 is a flow diagram of a method for obtaining a real-time detection of a DNS classification for a batch of DNS records according to various embodiments.

FIG. 8 is a flow diagram of a method for handling a DNS request and corresponding DNS response according to various embodiments.

FIG. 9 is a flow diagram of a method for classifying one or more DNS records according to various embodiments.

FIG. 10 is a flow diagram of a method for performing a post-filtering for classifying a candidate record according to various embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

As used herein, a security entity may be a network node (e.g., a device) that enforces one or more security policies with respect to information such as network traffic, files, etc. As an example, a security entity may be a firewall. As another example, a security entity may be implemented as a router, a switch, a DNS resolver, a computer, a tablet, a laptop, a smartphone, etc. Various other devices may be implemented as a security entity. As another example, a security may be implemented as an application running on a device, such as an anti-malware application.

As used herein, a model may include a machine learning model and/or a deep learning model. Examples of machine learning processes that can be implemented in connection with training the model include random forest, linear regression, support vector machine, naive Bayes, logistic regression, K-nearest neighbors, decision trees, gradient boosted decision trees, K-means clustering, hierarchical clustering, density-based spatial clustering of applications with noise (DBSCAN) clustering, principal component analysis, etc.

As used herein, a DNS hijacked domain may include a domain corresponding to a DNS record classified or otherwise deemed as a DNS hijacking record.

As used herein, a DNS record may comprise a resource record triplet (rrname, rrtype, rrdata).

DNS hijacking refers to the occurrence of a malicious actor taking control of the DNS records for a victim domain and inserting new records or modifying old records. Attackers hijack DNS records to attack visitors of the domain name by serving the visitors malicious content including man-in-the-middle (MitM) attacks, drive-by-download, phishing and scams. Alternatively, malicious actors can hijack domain names to use the domain reputation for malicious campaigns independent of the visitors to the victim domain. Malicious actors can use any of several techniques to hijack DNS records. An example technique is the malicious actor can take over the domain owner's account at a domain registrar or at a DNS service provider (or alternatively infiltrate the registrar/DNS service provider). The malicious actor can take over the account, for example, via phishing, password guessing, or a breach of another site. Another example technique is the malicious actor can hijack DNS records via DNS cache poisoning or other attacks targeting DNS.

In DNS hijacking attacks, malicious actors modify resource records (RRs) or add new resource records that belong to another entity without such other entity's permission. These changes (e.g., the modified or new RRs) are often very short lived because the owner of the domains will notice the change and recover the domains. However, even the short duration can cause considerable damages both to the reputation of the domain owner and the safety of their customers/users. Sometimes these attacks occur in an orchestrated manner (e.g., campaigns) as part of a larger attack. Therefore, uncovering these instances can help in detecting larger malicious behaviors, and if a system detects the occurrence of the attack in time, can prevent significant damages.

Various embodiments provide a method and system configured to detect the attacks as soon as (or shortly after) the attacks occur. Additionally, various embodiments provide a method and system for identifying the attacks currently being perpetrated or that occurred in the recent past (e.g., 1 day). The method uses a set of features extracted from a variety of data sources to query a classifier for a classification of whether the record is a DNS hijacking record. In some embodiments, the system identifies the attacks within a predetermined period of time of DNS traffic being collected (e.g., the observation or collection of a DNS record comprised in the DNS response for the DNS request). The predetermined of time can be less than 1 day.

According to various embodiments, the system performs a real-time classification for the DNS record classification. In some embodiment, the system determines a DNS record classification (e.g., for a newly observed DNS record) in less than 25 minutes. In some embodiments, the system determines the DNS record classification in more than 100 ms after the DNS record being newly observed and in less than 1 hour of the DNS being observed/collected.

Various embodiments provide security services to customers (e.g., domain owners, or users that access domains, such as via traffic across an enterprise network) by detecting hijacked DNS records. The system can detect the hijacked DNS records by leveraging passive DNS logs and auxiliary information. In some embodiments, the system tracks new DNS records and then extracts features about the new DNS records using passive DNS (pDNS) data and geolocation data. The system uses these features to query a machine learning model that is configured to predict the likelihood of a record being hijacked (e.g., DNS hijacked) or not. Because hijacked records can sometimes exhibit similar behavior to normal records, in some embodiments, the system uses auxiliary information such as web crawls, WHOIS, and zone files information to perform a post filtering to decide if a record is truly hijacked.

Various embodiments provide a system, method, or device for detecting hijacked records (e.g., DNS hijacking records). The method includes (i) obtaining passive DNS (pDNS) data and geolocation data pertaining to a set of resource records, (ii) extracting a first set of features based at least in part on the pDNS data for a selected resource record, (iii) using a classifier to determine whether a candidate record corresponding to the selected resource record is a result of a DNS hijacking based at least in part on the first set of features, and (iv) performing an active measure in response to determining that the candidate record is the result of the DNS hijacking. The selected record is selected from the set of resource records.

Various embodiments provide a system, method, or device for detecting hijacked domains. The method includes (i) filtering a set of DNS records in real-time to filter out DNS records determined not to be associated with DNS hijacking and store an indication of a set of resultant filtered DNS records, (ii) detecting DNS hijacking records based at least in part on processing a batch of resultant filtered DNS records, and (iii) performing an active measure in response to detecting the DNS hijacking records. The set of resultant filtered DNS records are batched according to a predefined timeframe. The processing of the batch of resultant filtered records includes (a) determining if a particular record is a candidate record for DNS hijacking, and (b) in response to determining that the particular record is the candidate record for DNS hijacking, generating a set of features for the candidate record for DNS hijacking, and determining whether the candidate record is a DNS hijacking record based at least in part on querying a classifier using the set of features.

Various embodiments provide a system, method, or device for training a hijacked domain classifier. The method includes (i) obtaining a set of training candidate domains; (ii) obtaining a set of pDNS data for the set of training candidate domains, the set of pDNS data comprising data for a set of organic DNS records and data for a set of simulated DNS hijacking records, (iii) performing a machine learning process to generate a hijacked domain classifier based at least in part on the set of pDNS data for the set of training candidate domains; (iv) and deploying the hijacked domain classifier in a system to perform detection of hijacked domains.

In some embodiments, the classifier or model used in connection with generating a prediction of whether a domain is subject to DNS hijacking (e.g., that a DNS record is predicted to be a DNS hijacking record) is a machine learning model that is trained using a machine learning process. Examples of machine learning processes that can be implemented in connection with training the model(s) include random forest, support vector machine, naive Bayes, logistic regression, various neural networks, etc. In some embodiments, the system trains a random forest machine learning domain classification model.

In some embodiments, a detection pipeline to detect DNS hijacking is periodically executed to update record classifications, which can used in connection with performing an active measure and/or can be published to security entities or network nodes via domain allowlists or denylists. The detection pipeline can be executed in connection with classifying batches of DNS records. The system can collect observed DNS records in batches, such as over a predetermined period of time (e.g., 1 minute, 2 minutes, 5 minutes, 10 minutes, less than 30 minutes, etc.). In some embodiments, the system determines DNS record classification in batches in connection with providing real-time detection of DNS hijacking records (e.g., DNS record classifications contemporaneous with the interception or handling of traffic).

According to various embodiments, the system uses passive DNS data (e.g., obtained by querying a pDNS dataset) to obtain the history of resource records (RRs), and passes this data (e.g., the pDNS data and/or the history data) to a feature extractor module/service to obtain a set of features. The feature extraction module obtains the history data and for example looks for changes observed in rrname-rrdata pairs. For example feature extractor extracts a set of features by comparing the statistics of the past rrdata for the rrname-rrdata pairs in addition to the statistics of the new rrdata. In some implementations, the feature extractor extracts a set of 74 features (e.g., to be used in a model). The feature extraction module is also configured to extract a set of domain features such as the number of new IPs seen in the domain's A records (e.g., obtained from the pDNS data) in the recent past. Examples of the features extracted based at least in part on the pDNS data are provided in Tables 1 and 2 below. In response to performing feature extraction, the system passes the extracted features to a machine learning (ML) model that predicts the verdict (e.g., the ML model generates a prediction that corresponds to a likelihood that the domain is a DNS hijacked domain).

In some embodiments, at least for a subset of the features to be computed for the DNS record classification, pre-computed data can be used. For example, the classifier can use pre-computed data in connection with determining/providing a real-time DNS record classification (e.g., to detect DNS hijacking records in real-time).

Optionally, the system implements a post-processing/post-filtering technique that filters the verdicts generated by the ML model to obtain classifications of whether the domain is a DNS hijacked domain. The classifications generated by performing the post-filtering technique increases the confidence in the verdicts, particularly by reducing the rate of potential false positive verdicts. In some implementations, the post-filtering technique comprises two steps. In the first step, the system performs a comparative analysis of the web contents hosted on the hijacked address and the original address and/or a comparative analysis of the corresponding certificates. If the content is the same on both IP addresses, then the system concludes that the new record is not a hijacked record. Additionally, if the collected WHOIS data indicates that the domain is newly registered or that the ownership recently changed, then the system (e.g., the DNS hijacking record detection pipeline) will not consider the record as hijacked (e.g., the DNS record will not be deemed to have been a result of a DNS hijacking attack). In the second step, the system uses a length of time over which the rrdata for a new record persists to filter the verdicts. If the rrdata for a new record persists over a duration of time (e.g., more than a threshold period of time), the verdict is filtered out or the classification for the candidate domain is changed to indicate that the candidate is benign. The system uses the length of time over which rrdata for a new record is persisted to filter the verdicts because of the generally short-lived nature of a DNS hijacking attack.

According to various embodiments, the system uses DNS hijacking record classifications to block DNS responses for such DNS hijacking records from reaching customers or the security service (e.g., customer enterprise networks, or client systems managed by or connected to the enterprise network). One reason to block a DNS response if it comprises a resource record resulting from DNS hijacking is that the system (e.g., a security system) can enable customers to access the domain if the DNS response they receive is benign or not the result of DNS hijacking.

According to various embodiments, the system looks at all DNS resource records (or “records”) observed in a timeframe (e.g. 1 minutes, 5 minutes, 10 minutes or some other predefined period such as a time period less than 1 day or 12 hours). From these collected observed records using candidate selection and leveraging pDNS, the system selects candidate DNS hijacking records (or “candidate records”). The system uses pre-computed data and extracts features for these candidate records using at least pDNS (e.g., the system can additionally collect data about the root portion of rrname and the rrdata) and geolocation, and classify (e.g., using a classifier such as a machine learning model) the candidate records as DNS hijacking records or not DNS hijacking records. In some embodiments, the system collects additional information about DNS hijacking records to filter potential false positives.

In some embodiments, the system performs a DNS hijacking classification for new DNS records based at least in part on a signature. For example, the system can store a mapping of signatures to DNS hijacking records. In response to receiving a new DNS record for DNS hijacking classification, the system can determine whether the new DNS record matches any of the signatures mapped to DNS hijacking records. An example of a signature that may be added is: <*.hijacked-domain.com,A, 23.45.67.*>. All records matching the signature (e.g., <xyz.hijacked-domain.com,A, 23.45.67.44>) can be deemed a DNS hijacking record. For example, records matching the signature could be blocked.

A major challenge for training a machine learning model is to have access to a large and good set of labeled samples. Unfortunately, such datasets do not exist for DNS hijacking attacks. For example, a manual investigation of passive DNS data and public threat intelligence uncovered fewer than 100 samples, which is not enough to train and test a classifier. To solve this issue, various embodiments implement a technique to generate simulated DNS hijacking attack campaigns. In some embodiments, the system generates simulated DNS hijacking records. The technique for generating simulated DNS hijacking attack campaigns may have parameters that can be adjusted to generate hijacking campaigns with different levels of detection difficulties. The simulated hijacking records are then inserted into the a pDNS dataset to create datasets that very closely resemble real-world hijacking scenarios. This data (e.g., the pDNS dataset comprising a subset of organic DNS records and a subset of synthetic DNS records) is utilized to train and evaluate the machine learning model that is used to detect DNS hijacking attacks (or to detect malicious domains).

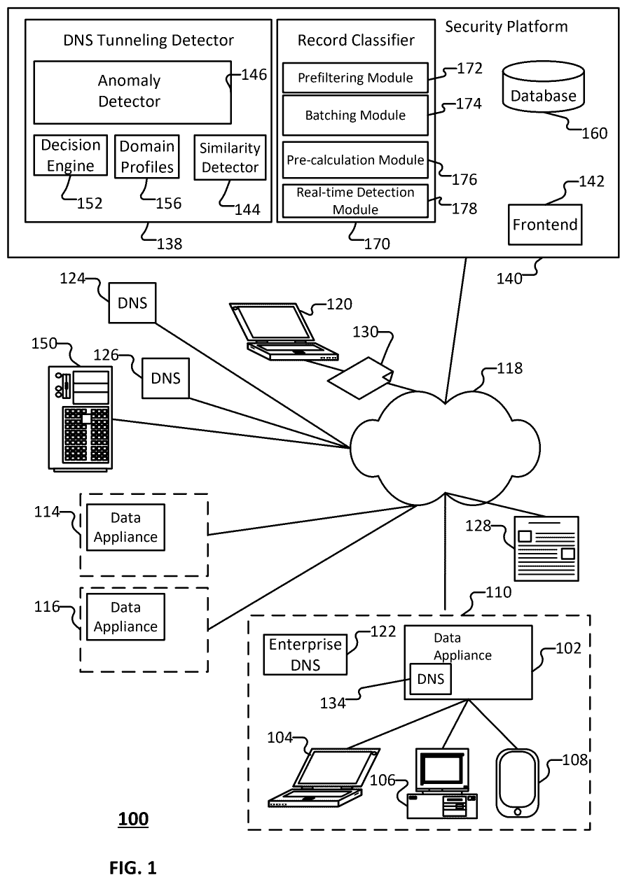

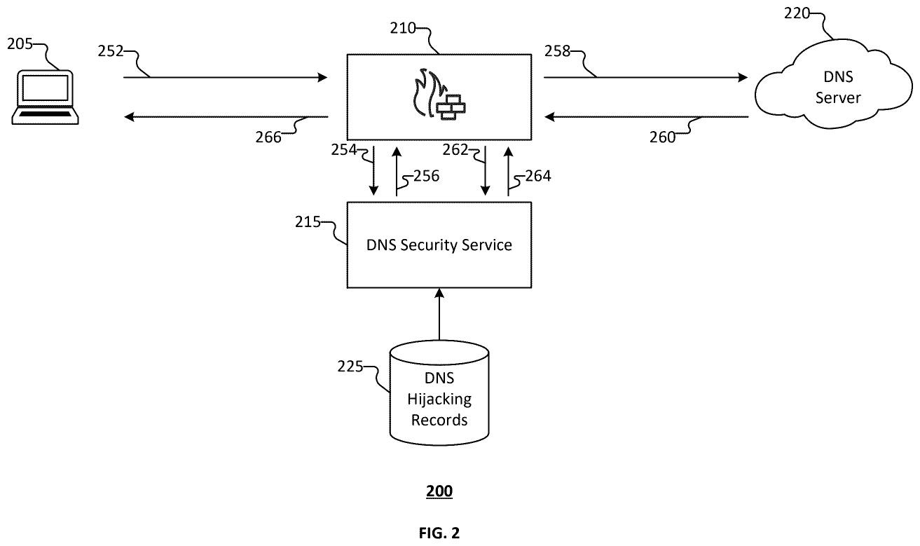

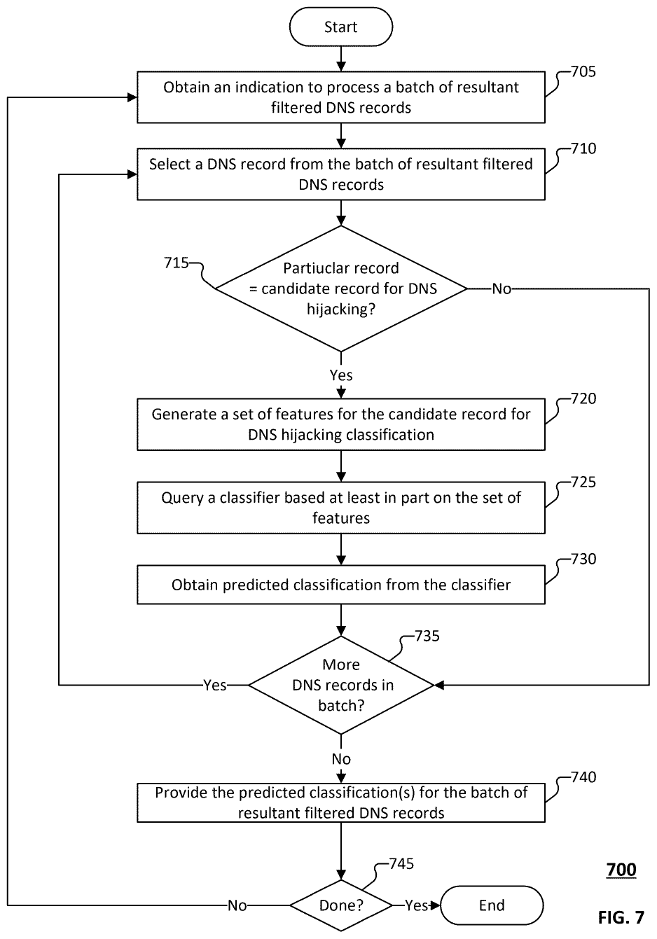

FIG. 1 is a block diagram of an environment for providing a security service to a network according to various embodiments. In various embodiments, system 100 is implemented in connection with one or more of systems 300-500 of FIGS. 2-5, or one or more of processes 700-1000 of FIGS. 7-10.

In the example shown, client devices 104-108 are a laptop computer, a desktop computer, and a tablet (respectively) present in an enterprise network 110 (belonging to the “Acme Company”). Data appliance 102 is configured to enforce policies (e.g., a security policy, a network traffic handling policy, etc.) regarding communications between client devices, such as client devices 104 and 106, and nodes outside of enterprise network 110 (e.g., reachable via external network 118). Examples of such policies include policies governing traffic shaping, quality of service, and routing of traffic. Other examples of policies include security policies such as ones requiring the scanning for threats in incoming (and/or outgoing) email attachments, website content, inputs to application portals (e.g., web interfaces), files exchanged through instant messaging programs, and/or other file transfers. Other examples of policies include security policies (or other traffic monitoring policies) that selectively block traffic, such as DNS responses comprising DNS hijacking records, or traffic to malicious domains, or stockpiled domains, or such as traffic for certain applications (e.g., SaaS applications). In some embodiments, data appliance 102 is also configured to enforce policies with respect to traffic that stays within (or from coming into) enterprise network 110.

Techniques described herein can be used in conjunction with a variety of platforms (e.g., desktops, mobile devices, gaming platforms, embedded systems, etc.) and/or a variety of types of applications (e.g., Android.apk files, iOS applications, Windows PE files, Adobe Acrobat PDF files, Microsoft Windows PE installers, etc.). In the example environment shown in FIG. 1, client devices 104-108 are a laptop computer, a desktop computer, and a tablet (respectively) present in an enterprise network 110. Client device 120 is a laptop computer present outside of enterprise network 110.

Data appliance 102 can be configured to work in cooperation with remote security platform 140. Security platform 140 can provide a variety of services, including classifying domains (e.g., predicting whether a domain is a malicious domain, etc.), classifying DNS response records (e.g., predicting whether a domain IP pair in a DNS response is a DNS hijacking record, etc.), classifying network traffic, providing a mapping of signatures to certain domains or DNS records (e.g., a DNS record for which a predicted likelihood that the record is a DNS hijacking record exceeds a predefined likelihood threshold, etc.), a mapping of domains or DNS records to domain or DNS record data (e.g., domain certificates, pDNS data, active DNS data, WHOIS data, etc.), performing static and dynamic analysis on malware samples, monitoring new domains and new DNS records (e.g., detecting new domains for which a certificate is issued/generated), assessing maliciousness of domains, determining whether a DNS record associated with a traffic sample is (or is likely to be) a DNS hijacking record, providing a list of signatures of known exploits (e.g., malicious input strings, malicious files, malicious domains, etc.) to data appliances, such as data appliance 102 as part of a subscription, detecting exploits such as malicious input strings, malicious files, DNS hijacking records or malicious domains (e.g., an on-demand detection, or periodical-based updates to a mapping of domains or DNS records to indications of whether the domains or DNS records are malicious or benign), providing a likelihood that a domain is malicious (e.g., a DNS hijacking record) or benign (e.g., not DNS hijacked), providing/updating an allowlist of input strings, files, or domains deemed to be benign, providing/updating input strings, files, or domains deemed to be malicious, identifying malicious input strings, detecting malicious input strings, detecting malicious files, predicting whether input strings, files, DNS records, or domains are malicious, providing an indication that an input string, file, DNS record, or domain is malicious (or benign). In some embodiments, services provided by security platform 140 additionally comprise simulating DNS hijacking attacks/campaigns (e.g., generating simulated DNS hijacking records), and/or training classifiers (e.g., training machine learning models, such as to be used to provide detection of DNS hijacked records).

In some embodiments, security platform 140 classifies the domains in response to receiving a network traffic sample or according to a predefined schedule. In connection with detecting DNS hijacking records, security platform 140 can obtain information pertaining to the records (e.g., pDNS data, geolocation data, etc.) and classify the DNS records based at least in part on querying a machine learning model. Security platform 140 may perform periodic polling or monitoring of pDNS data and geolocation data, such as in connection with training a classifier, and/or classifying a set of domains or DNS records. Security platform 140 may process the collected records and corresponding data pertaining to the domains (e.g., the pDNS data, the geolocation data, etc.) in batches such as according to a predefined frequency (e.g., daily, weekly, etc.). The predefined frequency is less than daily. The periodic polling or monitoring may be performed according to a predefined schedule or a predefined frequency or time period (e.g., daily, weekly, monthly, etc.).

According to various embodiments, security platform 140 determines (e.g., predicts) a domain or DNS record classification in response to receiving a DNS request or DNS response from an endpoint or network entity, such as a data appliance or other firewall or security entity. For example, security platform 140 can perform a real-time DNS record classification for the obtained DNS records. Security platform 140 may determine DNS record classification in batches, such as according to predefined time periods/intervals and processes the batches to provide a real-time DNS classification. The system can collect observed DNS records in batches, such as over a predetermined period of time (e.g., 1 minute, 2 minutes, 5 minutes, 10 minutes, less than 30 minutes, etc.). In some embodiments, the system determines DNS record classification in batches in connection with providing real-time detection of DNS hijacking records (e.g., DNS record classifications contemporaneous with the interception or handling of traffic). The predetermined period of time may be less than 1 day, 1 hour, and preferably less than 30 minutes.

In connection with providing real-time DNS record classifications, security platform 140 receives certain pre-computed or pre-collected data, such as to reduce the latency in classifying a DNS record. Security platform 140 can pre-compute or pre-collect the data according to a predetermined period of time which is longer than the period of time used to determine batches of DNS records. For example, security platform 140 pre-computes or pre-collects the data less frequently than it performs real-time DNS record classifications. The pre-computed data can be used to more efficiently calculate a set of features, such as at least a subset of the features used by the classifier (e.g., the machine learning model) in connection with determining the DNS record classification. Additionally, or alternatively, the pre-collected data includes pDNS data, geolocation data for the domains associated with the set of DNS records. The pre-computed data can include pDNS subnet history extracted from the pre-collected pDNS data.

In various embodiments, results of analysis (and additional information pertaining to applications, domains, etc.), such as an analysis or classification performed by security platform 140, are stored in database 160. In various embodiments, security platform 140 comprises one or more dedicated commercially available hardware servers (e.g., having multi-core processor(s), 32G+ of RAM, gigabit network interface adaptor(s), and hard drive(s)) running typical server-class operating systems (e.g., Linux). Security platform 140 can be implemented across a scalable infrastructure comprising multiple such servers, solid state drives, and/or other applicable high-performance hardware. Security platform 140 can comprise several distributed components, including components provided by one or more third parties. For example, portions or all of security platform 140 can be implemented using the Amazon Elastic Compute Cloud (EC2) and/or Amazon Simple Storage Service (S3). Further, as with data appliance 102, whenever security platform 140 is referred to as performing a task, such as storing data or processing data, it is to be understood that a sub-component or multiple sub-components of security platform 140 (whether individually or in cooperation with third party components) may cooperate to perform that task. As one example, security platform 140 can optionally perform static/dynamic analysis in cooperation with one or more virtual machine (VM) servers. An example of a virtual machine server is a physical machine comprising commercially available server-class hardware (e.g., a multi-core processor, 32+ Gigabytes of RAM, and one or more Gigabit network interface adapters) that runs commercially available virtualization software, such as VMware ESXi, Citrix XenServer, or Microsoft Hyper-V. In some embodiments, the virtual machine server is omitted. Further, a virtual machine server may be under the control of the same entity that administers security platform 140 but may also be provided by a third party. As one example, the virtual machine server can rely on EC2, with the remaining portions of security platform 140 provided by dedicated hardware owned by and under the control of the operator of security platform 140.

In some embodiments, DNS record classifier 170 detects/classifies a domain. For example, DNS record classifier 170 predicts whether a particular DNS record (e.g., a candidate record) is a DNS hijacking record (e.g., whether the candidate record is a DNS hijacked record). Alternatively, DNS record classifier 170 can predict whether a particular domain is a DNS hijacked domain (e.g., is associated with a DNS hijacking record). In some embodiments, DNS record classifier 170 classifies the domain or DNS record based at least in part on a signature of the candidate domain or DNS record, such as by querying a mapping of signatures to domain or DNS record identifiers (e.g., a set of previously analyzed/classified domains or DNS records). As an example, DNS record classifier 170 uses a signature or domain or DNS record identifier to query a denylist of domains to check whether the candidate domain or the domain of the DNS record is on the denylist of domains. In some embodiments, DNS record classifier 170 classifies the domain or DNS record based on a predicted domain or DNS record classification (e.g., a prediction of whether a candidate DNS record is a DNS hijacking record, whether the candidate record is not a DS hijacked record, or whether a candidate domain is malicious or benign, etc.). For example, DNS record classifier 170 determines (e.g., predicts) the DNS record classification based at least in part on domain or DNS record data for the candidate domain or DNS record. Examples of domain or DNS record data include a certificate information pertaining to a certificate(s) associated with the candidate domain (e.g., the domain associated with the particular DNS request or response), registration information, pDNS data, geolocation data, scan data, active DNS information, zone file information, WHOIS registry data, web crawl data (e.g., data obtained by crawling the website), etc.

In some embodiments, DNS record classifier 170 determines a domain or DNS record classification for a candidate domain or DNS record based at least in part on a machine learning-based classification. As an example, DNS record classifier 170 uses a machine learning-based classifier to determine a prediction of whether the candidate DNS record is a DNS hijacking record. Additionally, or alternatively, DNS record classifier 170 may implement one or more of a fingerprinting-based classification, a heuristics-based classification, or other rule-based classification to classify the candidate domain or DNS record. For example, DNS record classifier 170 performs a post-filtering with respect to the predictions generated by the machine learning-based classifier. The post-filtering can be performed using a fingerprinting-based classifier, a heuristics-based classifier, and/or other rule-based classifier to filter out potential false positives generated by the machine learning-based classifier (e.g., to remove predicted candidate DNS records that are likely not DNS hijacked domains).

In some embodiments, DNS record classifier 170 includes a model (e.g., a machine learning model) that is trained to detect DNS hijacked records or DNS hijacked attacks/campaigns. In some embodiments, DNS record classifier 170 (e.g., the real-time detection module 178) is trained to detect DNS hijacking records. In response to determining a predicted classification for a domain or DNS records (e.g., a candidate domain or candidate DNS record), DNS record classifier 170 may determine a signature for the domain or DNS record and store the signature in a mapping of signatures to domains or DNS record classifications (e.g., an indication of whether the candidate domain or DNS record is malicious/DNS hijacked or benign/non-DNS hijacked) the domain or DNS record signature in association with the predicted classification.

In some embodiments, system 100 (e.g., DNS record classifier 170, security platform 140, etc.) trains a classifier (e.g., a model) to detect (e.g., predict) DNS hijacking records (e.g., to predict a DNS record classification for a particular DNS record, such as DNS records intercepted by an inline security entity). The classifier is trained based at least in part on a machine learning process. Examples of machine learning processes that can be implemented in connection with training the classifier(s) include random forest, support vector machine, naive Bayes, logistic regression, a neural network (NN), etc. In some embodiments, DNS record classifier 170 implements a random forest model.

System 100 (e.g., DNS record classifier 170, security platform 140, etc.) performs feature extraction with respect to the candidate record from domain or DNS record data (e.g., pDNS data, geolocation data, certificates, registrant information, scan data, etc.). In some embodiments, system 100 (e.g., DNS record classifier 170) generates a set of features for training a machine learning model for classifying the DNS record (e.g., classifying whether the record are DNS hijacked or non-DNS hijacked). System 100 then uses the set of features to train a machine learning model (e.g., a random forest model) such as based on training data that includes non-hijacked samples of domains or DNS records and hijacked samples of domains or DNS records. At least for a subset of the features pre-computed data is used so DNS record classifier 170 can use the features to perform a real-time DNS record classification.

In some embodiments, system 100 (e.g., DNS record classifier 170, security platform 140, etc.) simulates DNS hijacking attacks/campaigns. For example, system 100 generates simulated DNS hijacking attacks/campaigns (e.g., synthetic records from organic and/or synthetic data) to increase the number of training samples with which the machine learning model can be trained.

According to various embodiments, security platform 140 comprises DNS tunneling detector 138 and/or DNS record classifier 170. Security platform 140 may include various other services/modules, such as a malicious file detector, a malicious traffic detector, a parked domain detector, a DNS hijacked domain or DNS record detector, an application classifier or other traffic classifier, etc. DNS record classifier 170 is used in connection with analyzing samples of records and/or automatically detecting DNS hijacked records. For example, DNS record classifier 170 analyzes a candidate record and predicts whether the corresponding domain or DNS record is malicious or otherwise corresponds to a DNS hijacking record (e.g., that the domain has been subject to a DNS hijacking attack). In response to receiving an indication that an assessment of a candidate record (e.g., a domain or DNS record classification, determine whether the candidate domain or DNS record is DNS hijacked/non-DNS hijacked, etc.) is to be performed, DNS record classifier 170 analyzes the candidate record and obtains domain or DNS record data (e.g., pDNS data, geolocation data, etc.) for the candidate record to determine the assessment of the candidate record.

In some embodiments, in connection with determining the machine learning-based prediction classification, DNS record classifier 170 (i) receives an indication of a candidate record or otherwise performs a candidate record selection, (ii) obtains information pertaining the candidate record (e.g., domain or DNS record data such as pDNS data, geolocation data, etc.), (iii) determines a feature vector for the candidate domain based on the information pertaining to the candidate record, (iv) queries a model (e.g., a machine learning model), and (v) determines a DNS record classification, or otherwise whether the domain is a DNS hijacked domain (e.g., that the corresponding DNS record has been subject to a DNS hijacking attack) based on the querying the model (e.g., DNS record classifier 170 obtains a predicted classification). Additionally, DNS record classifier 170 can batch collected/observed DNS records and perform real-time DNS record classification in batches. The batches can be determined based at least in part on a predetermined batching time period, which can be configured based on a level of service for providing real-time DNS record detection.

In some embodiments, DNS record classifier 170 comprises one or more of prefiltering module 172, batching module 174, pre-calculation module 176, and real-time detection module 178.

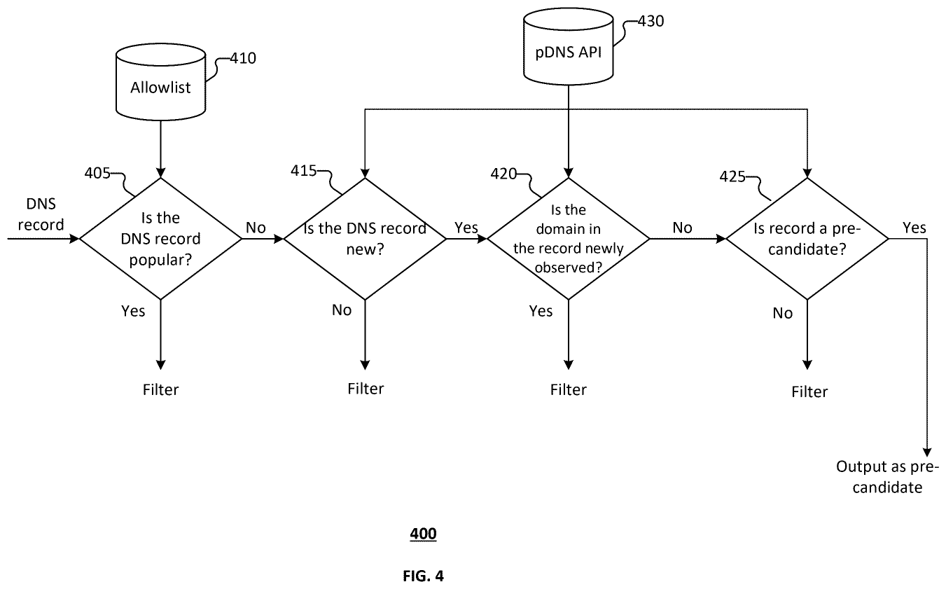

Prefiltering module 172 prefilters collected/observed DNS records to determine a subset of collected/observed DNS records for which the system is to query a classifier (e.g., an ML model) for a DNS record classification. In some embodiments, prefiltering module 172 implements system 400 of FIG. 4 in connection with prefiltering the collected/observed DNS records. Prefiltering module 172 can prefilter the collected/observed DNS records to obtain a set of one or more pre-candidate records based at least in part on one or more of (i) the popularity of the DNS record, (ii) the number and diversity of records related to the domain in the DNS records, (iii) a determination that the DNS record is a new record, (iv) a determination that the DNS record comprises a newly observed hostname, (v) a determination of whether the DNS record can be classified as a pre-candidate record. For example, prefiltering module 172 prefilters the collected/observed DNS records based at least in part on a predefined allowlist and pDNS data.

Batching module 174 batches DNS records, for example, the DNS records (e.g., the pre-candidate records) resulting from the prefiltering. Batching module 174 batches the DNS records based at least in part on a predetermined batching period of time. The batching period of time can be configured based on a level of service for providing real-time DNS record classifications. Batching module 174 can collect observed DNS records in batches, such as over a predetermined period of time (e.g., 1 minute, 2 minutes, 5 minutes, 10 minutes, less than 30 minutes, etc.).

Pre-calculation module 176 pre-collects certain data (e.g., domain data such as pDNS data) and pre-computes data that is to be used in connection with DNS record classifier 170 providing a real-time DNS record classification. In some embodiments, the pre-collected data comprises pDNS data, geolocation data (e.g., location data for an IP address associated with a record/domain), etc. Pre-calculation module 176 can determine a set of precomputed data and subnet history data. Pre-calculation module 176 can pre-collect the data and/or pre-compute the data less frequently than the predefined batching period of time (e.g., the batches are processed more frequently than the data is pre-collected or pre-computed).

Pre-calculation module 176 may query a dataset or third-party service(s) for domain data or DNS record data. For example, Pre-calculation module 176 may query a WHOIS database for registrant information, passive DNS (pDNS) datasets or logs, active DNS datasets or logs, geolocation datasets or services, certificate logs (e.g., to obtain certificates for the particular domain), etc. Pre-calculation module 176 extracts information from the domain data, the corresponding DNS record data, or the domain name itself.

Real-time detection module 178 performs a real-time DNS record classification. Real-time detection module 178 performs the real-time DNS record classification based at least in part on (a) a set of pre-candidate records (e.g., comprised in the current batch being processed), and (b) the pre-collected data and/or pre-computed data. In some embodiments, real-time detection module 178 implements (e.g., comprises and/or queries) a classifier (e.g., a machine learning model) to generate a predicted DNS record classification. Optionally, real-time detection module 178 may additionally perform a post-filtering of the DNS record classifications to obtain those DNS records that are to be deemed DNS hijacking records.

In some embodiments, the classifier is trained using a machine learning process. For example, the classifier is a random forest model. The random forest model may be trained from a training set comprising a subset of benign records or domains (e.g., known records) and a subset of malicious records (e.g., records known or previously classified malicious/DNS hijacked domains).

In some embodiments, real-time detection module 178 receives, from the machine learning model, an indication of a likelihood that the candidate record corresponds to a DNS hijacking record, a likelihood that the candidate record is not a DNS hijacking record, etc. In response to receiving the indication of the likelihood that the candidate record corresponds to a DNS hijacking record or a likelihood that the candidate record is not a DNS hijacking record, real-time detection module 178 determines (e.g., predicts) a record classification based on such likelihood. For example, real-time detection module 178 compares the likelihood that the candidate record corresponds to a DNS hijacking record to a likelihood threshold value. In response to a determination that the likelihood that the candidate record corresponds to a DNS hijacking record is greater than the likelihood threshold value, real-time detection module 178 may deem (e.g., determine that) the candidate record to correspond to a DNS hijacking record.

According to various embodiments, in response to real-time detection module 178 classifying the candidate record, system 100 handles the DNS response corresponding to the record according to a predefined policy (e.g., a security policy). For example, in response to predicting that the candidate record is a DNS hijacking records, system 100 can cause the DNS response to be blocked or quarantined, etc.

According to various embodiments, in response to real-time detection module 178 classifying the candidate record, system 100 handles DNS requests and responses about the domain or the traffic to/from the candidate domain according to a predefined policy (e.g., a security policy). For example, the system queries a traffic handling policy to determine the manner by which DNS traffic matching the candidate domain is to be handled. The traffic handling policy may be a predefined policy, such as a security policy, etc. The traffic handling policy may indicate that traffic to/from certain domains is to be blocked and traffic to/from other domains is to be permitted to pass through the system (e.g., routed normally). The traffic handling policy may correspond to a repository of a set of policies to be enforced with respect to network traffic. In some embodiments, security platform 140 receives one or more policies, such as from an administrator or third-party service, and provides the one or more policies to various network nodes, such as endpoints, security entities (e.g., inline firewalls), etc.

In response to determining a classification for a newly analyzed candidate record, security platform 140 (e.g., DNS record classifier 170) sends an indication that records matching the candidate record are associated with, or otherwise correspond to, the determined classification. In the case that the determined classification for the candidate record is that the candidate record is a DNS hijacking record, security platform 140 provides an indication that DNS responses comprising the DNS hijacking record to be blocked. Security platform 140 can provide an indication that DNS responses corresponding to the candidate record to be handled as a DNS hijacking record. For example, security platform 140 determines (e.g., computes) a signature or identifier for the domain or DNS record for the candidate record (e.g., a hash or other signature), and sends to a network node (e.g., a security entity, an endpoint such as a client device, etc.) an indication of the classification associated with the signature (e.g., an indication whether the record is a DNS hijacking record, or an indication of whether the domain is a malicious/non-malicious domain, or an indication of whether traffic to/from the domain is malicious traffic). Security platform 140 may update a mapping of signatures to domain or DNS record classifications and provide the updated mapping to the security entity. In some embodiments, security platform 140 further provides to the network node (e.g., security entity, client device, etc.) an indication of a manner by which traffic to a domain or DNS record matching the signature is to be handled. For example, security platform 140 provides to the security entity a traffic handling policy, a security policy, or an update to a policy.

In some embodiments, system 100 (e.g., DNS record classifier 170 of security platform 140, or other security entity, etc.) determines whether information pertaining to a particular candidate record (e.g., a newly received candidate record to be analyzed) is comprised in a dataset of historical domains (e.g., historical network traffic, previously classified domains), whether a particular signature is associated with malicious traffic, or whether traffic corresponding to the candidate record to be otherwise handled in a manner different than the normal traffic handling. The historical information may be provided by another system or module, such as a service running on security platform 140, or by a third-party service such as VirusTotal™, or both. In response to determining that information pertaining to a candidate record (or corresponding domain) is not comprised in, or available in, the dataset of historical domains (e.g., historical or previously analyzed domains), system 100 (e.g., DNS record classifier 170 or other security entity) may deem that the domain/traffic has not yet been analyzed and system 100 can invoke an analysis (e.g., a domain analysis) of the candidate record (e.g., an analysis of the domain or DNS record data for the candidate record) in connection with determining (e.g., predicting) the record (e.g., DNS record) classification. The historical information (e.g., from a third-party service, a community-based score, etc.) indicates whether other vendors or cyber security organizations deem the particular traffic as malicious or should be handled in a certain manner.

Returning to FIG. 1, suppose that a malicious individual (using client device 120) has created malware or malicious sample 130, such as a file, an input string, etc. The malicious individual hopes that a client device, such as client device 104, will execute a copy of malware or other exploit (e.g., malware or malicious sample 130), compromising the client device, and causing the client device to become a bot in a botnet. The compromised client device can then be instructed to perform tasks (e.g., cryptocurrency mining, or participating in denial-of-service attacks) and/or to report information to an external entity (e.g., associated with such tasks, exfiltrate sensitive corporate data, etc.), such as C2 server 150, as well as to receive instructions from C2 server 150, as applicable.

DNS hijacked domains, for example, can be domains used for scams, phishing, or to distribute C2 exploits or malware.

As an illustrative example, the environment shown in FIG. 1 includes three Domain Name System (DNS) servers (122-126). As shown, DNS server 122 is under the control of ACME (for use by computing assets located within enterprise network 110), while DNS server 124 is publicly accessible (and can also be used by computing assets located within network 110 as well as other devices, such as those located within other networks (e.g., networks 114 and 116)). DNS server 126 is publicly accessible but under the control of the malicious operator of C2 server 150. Enterprise DNS server 122 is configured to resolve enterprise domain names into IP addresses, and is further configured to communicate with one or more external DNS servers (e.g., DNS servers 124 and 126) to resolve domain names as applicable.

As mentioned above, in order to connect to a legitimate domain (e.g., www.example.com depicted as website 128), a client device, such as client device 104 will need to resolve the domain to a corresponding Internet Protocol (IP) address. One way such resolution can occur is for client device 104 to forward the request to DNS server 122 and/or 124 to resolve the domain. In response to receiving a valid IP address for the requested domain name, client device 104 can connect to website 128 using the IP address. Similarly, in order to connect to malicious C2 server 150, client device 104 will need to resolve the domain, “kj32hkjqfeuo32ylhkjshdflu23.badsite.com,” to a corresponding Internet Protocol (IP) address. In this example, malicious DNS server 126 is authoritative for *.badsite.com and client device 104's request will be forwarded (for example) to DNS server 126 to resolve, ultimately allowing C2 server 150 to receive data from client device 104.

Data appliance 102 is configured to enforce policies regarding communications between client devices, such as client devices 104 and 106, and nodes outside of enterprise network 110 (e.g., reachable via external network 118). Examples of such policies include ones governing traffic shaping, quality of service, and routing of traffic. Other examples of policies include security policies such as ones requiring the scanning for threats in incoming (and/or outgoing) email attachments, website content, information input to a web interface such as a login screen, files exchanged through instant messaging programs, and/or other file transfers, and/or quarantining or deleting files or other exploits identified as being malicious (or likely malicious). In some embodiments, data appliance 102 is also configured to enforce policies with respect to traffic that stays within enterprise network 110. In some embodiments, a security policy includes an indication that network traffic (e.g., all network traffic, a particular type of network traffic, etc.) is to be classified/scanned by a classifier that implements a pre-filter model, such as in connection with detecting malicious or suspicious domains, detecting parked domains, or otherwise determining that certain detected network traffic is to be further analyzed (e.g., using a finer detection model).

In some embodiments, security platform 140 comprises a network traffic classifier that provides to a security entity, such as data appliance 102, an indication of the traffic classification. For example, in response to detecting the C2 traffic, network traffic classifier sends an indication that the domain traffic corresponds to C2 traffic to data appliance 102, and the data appliance 102 may in turn enforce one or more policies (e.g., security policies) based at least in part on the indication. The one or more security policies may include isolating/quarantining the content (e.g., webpage content) for the domain, blocking access to the domain (e.g., blocking traffic for the domain), isolating/deleting the domain access request for the domain, ensuring that the domain is not resolved, alerting or prompting the user of the client device the maliciousness of the domain prior to the user viewing the webpage, blocking traffic to or from a particular node (e.g., a compromised device, such as a device that serves as a beacon in C2 communications), etc. As another example, in response to determining the application for the domain, the network traffic classifier provides to the security entity with an update of a mapping of signatures to applications (e.g., application identifiers).

FIG. 2 is a block diagram of a system to handle DNS requests and DNS responses according to various embodiments. System 200 is configured to provide DNS record classifications. In the example shown, system 200 comprises DNS security service 215 and DNS hijacking records dataset 225. System 200 may additionally comprise, or interface with, firewall 210, client system 205, and/or a DNS security service 215.

System 200 comprises an offline detection pipeline. The offline detection pipeline performs DNS record classification offline and stores the DNS classifications in a dataset, for example, a set of detected DNS hijacking records are stored in DNS hijacking records dataset 225. DNS security service 215, or another pipeline used to collect records (e.g., via interception of DNS traffic, such as by firewall 210) that were observed over a predetermined time period (e.g., one day) and the DNS records are processed offline to determine the corresponding DNS record classifications. The predetermined period of time over which records are collected is typically 1 day or longer. For example, the predetermined period of time is generally a period that does not lend itself to real-time DNS record detection. During processing of the collected DNS records (e.g., the DNS records observed over the previous day), the offline detection pipeline obtains data to be used for the DNS record classifications (e.g., pDNS data, geolocation data, subnet history data). For example, all features to be used by a classifier in the DNS record classification are computed during the processing of the collected DNS records. The offline detection pipeline stores the detected hijacking records in a datastore, such as a datastore comprising DNS hijacking records dataset 225. DNS hijacking records dataset 225 is then used later by firewall 210 (e.g., via DNS security service 215) to block DNS responses inline that contain DNS hijacking records.

At 252, firewall 210 obtains a DNS request from a client system 205 (e.g., a customer's systems). Firewall 210 may intercept the DNS request during the handling or mediating traffic to/from the client system 205. In response to obtaining the DNS request, firewall 210 sends the DNS request to DNS security service 215, such as in connection with querying DNS security service 215 for an indication of whether the DNS request is to be allowed. DNS security service 215 can determine whether the DNS request is to be allowed, such as based on querying an allow list or a historical dataset of classified domains. If DNS security service 215 determines that the DNS request is to be allowed, at 256, DNS security service 215 provides to firewall 210 an indication that the DNS request is allowed (otherwise, DNS security service 215 can provide an indication that the DNS request is to be disallowed). In response to receiving an indication that the DNS request is not to be allowed (e.g., is to be disallowed), firewall 210 can correspondingly apply a security policy with respect to the DNS request, such as to block DNS request. Conversely, in response to receiving an indication that the DNS request is to be allowed, at 258, firewall 210 allows the DNS request towards its destination through the internet to DNS server 220 (e.g., a third party service) for a DNS response (e.g., for the information to resolve the domain comprised in the DNS request). At 260, firewall 210 obtains the DNS response from a DNS server. Before providing the DNS response to client system 205, firewall 210 can query DNS security service 215 for an indication of whether the DNS response is to be allowed. At 262, firewall 210 provides the DNS response to DNS security service 215. In response to receiving the DNS response, DNS security service 215 can query a dataset of precomputed classifications (e.g., DNS record classifications processed offline, such as classifications as most recent as the previous day). DNS security service 215 determines whether the DNS response should be allowed or disallowed based on the historical classifications (e.g., the DNS hijacking records dataset 225). In response to determining that the DNS response is to be disallowed (e.g., based on determining that the record was previously classified as a DNS hijacking record), DNS security service 215 can provide an indication to firewall 210 that DNS response is to be disallowed and firewall 210 correspondingly applies a security policy, such as to block the DNS response. In response to determining that the DNS response is to be allowed, at 264, DNS security service 215 provides to firewall 210 the indication that the DNS response is to be allowed. In response to firewall 210 receiving an indication that the DNS response is allowed (e.g., that the corresponding record is not a DNS hijacking record), at 266, firewall 210 provides the DNS response to client system 205.

The goal of the offline pipeline is to automatically and efficiently detect DNS hijacking by analyzing large batches of records seen in a period of time (e.g., one day or such other frequency that does not lend itself to real-time detection). The goal of a real-time detection pipeline according to various embodiments is to decrease detection latency, the time it takes to classify records as DNS hijacked or not DNS hijacked (e.g., under 10 minutes). To achieve low detection latency, the real-time pipeline analyzes records one by one. However, candidate selection and feature calculation used in the offline pipeline for DNS record classifications generally requires use of big data sources such as pDNS, making the process expensive and slow and thus insufficient for real-time detections/classification of records one by one.

According to various embodiments, the system performs a prefiltering separately which is generally part of the candidate selection process in the offline pipeline. Additionally, the system filter slightly more records in the real-time pipeline compared to the offline pipeline to decrease computational costs. According to various embodiments, the system runs an expensive offline pre-calculation step which is not necessary in the offline pipeline, but is used for the real-time pipeline to reduce the latency and improve the capability of the system to provide real-time detections. Finally, the real-time pipeline only processes records for classification from DNS responses for which the system is providing a security service (e.g., the security service customer's DNS responses), while the offline pipeline can classify records from a large external pDNS database collected from global ISP vantage points (e.g., SIE).

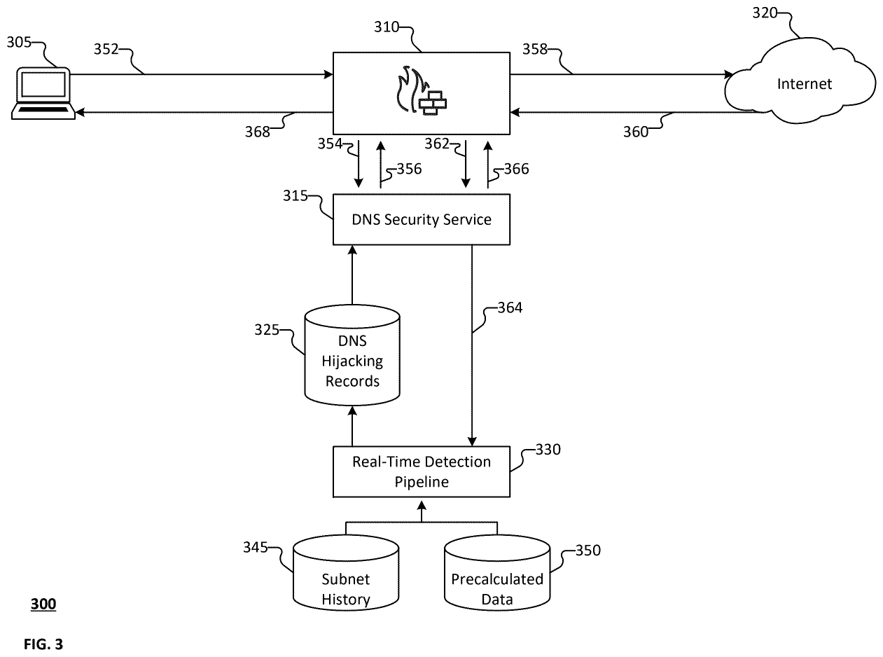

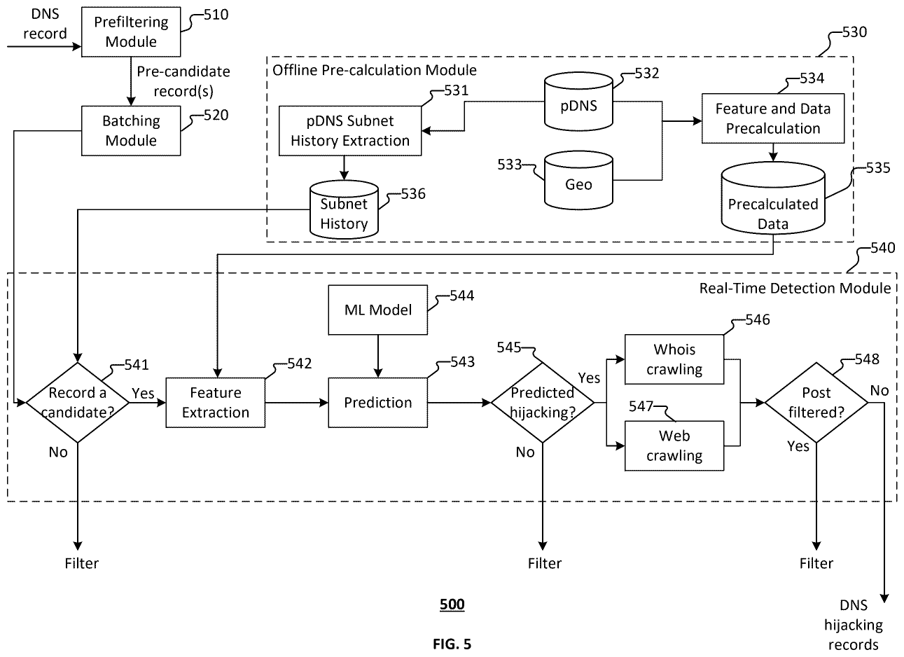

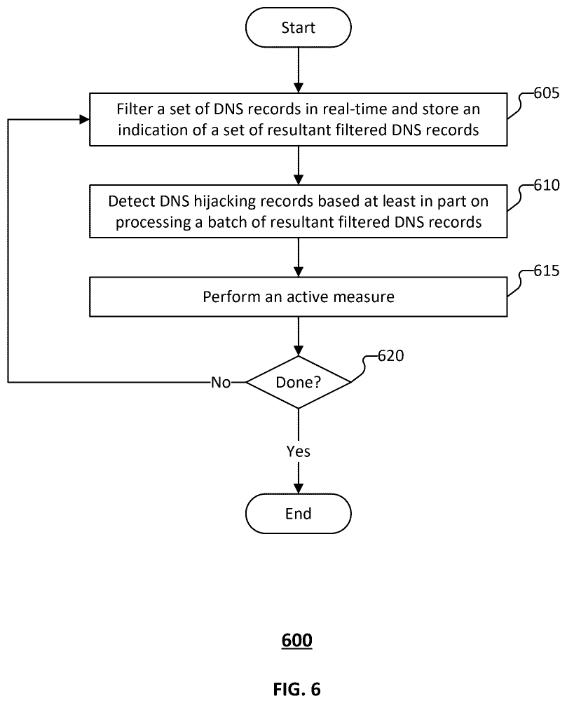

FIG. 3 is an illustration of a system for providing real-time detection of DNS hijacking records according to various embodiments. According to various embodiments, system 300 is implemented at least in part by system 100 of FIG. 1. System 300 implements system 400 of FIG. 4 and/or system 500 of FIG. 5. System 300 implements processes 600-1000 of FIGS. 6-10.

System 300 is configured to provide real-time DNS record classifications or real-time DNS hijacking record detections. System 300 implements a real-time DNS hijacking record pipeline (e.g., a real time detection pipeline) to provide the DNS record classifications/detections in sufficiently low latency to be used in real-time. For example, system 300 provides DNS record classifications in less than 30 minutes from the DNS record being first observed/collected. In some embodiments, system 300 provides the DNS record classifications between 1 minute and 30 minutes of the DS record being first observed/collected, and more preferably between 1 minute and 15 minutes, and more preferably in less than 10 minutes from the DNS record being first observed.

In the example shown, system 300 comprises DNS security service 315 and real-time detection pipeline 330, which can collectively provide real-time DNS record classifications to firewall 310. In some embodiments, system 300 additionally comprises DNS hijacking records dataset 325, pre-calculated data dataset 350, and pre-calculated subnet history dataset 345. Alternatively, system 300 may have access to DNS hijacking records dataset 325, pre-calculated data dataset 350, and pre-calculated subnet history dataset 345 for querying in connection with system 300 providing real-time detections.

The real-time detection pipeline is different from the offline detection pipeline in that when DNS security service 315 receives a DNS response from firewall 310 (e.g., at 362), then this DNS response will be sent to the real-time detection pipeline immediately. For example, the response is provided to the real-time detection pipeline 330 in less than a second. Real-time detection pipeline 330 will start processing the records in the DNS response right away and store detected DNS hijacking records in a datastore (e.g., DNS hijacking records dataset 325), similar to the offline detection pipeline. According to various embodiments, a difference between the offline detection pipeline and real-time detection pipeline 330 is that the DNS hijacking records will be available in the datastore (e.g., DNS hijacking records dataset 325) much faster (e.g. under 10 minutes). Accordingly, real-time detection pipeline 330 reduces the risk of DNS traffic to only permitting DNS traffic to pass without DNS classification for the time taken by the real-time detection pipeline 330 to classify the DNS record. In contrast, potentially malicious DNS traffic is permitted to pass through firewall 310 for longer periods when the offline detection pipeline is implemented because the offline detection pipeline introduces a larger latency in the DNS record classification (e.g., by performing daily DNS record classifications, etc.).

At 352, firewall 310 obtains a DNS request from a client system 305 (e.g., a customer's systems). Firewall 310 may intercept the DNS request during the handling or mediating traffic to/from the client system 305. In response to obtaining the DNS request, firewall 310 sends the DNS request to DNS security service 315, such as in connection with querying DNS security service 315 for an indication of whether the DNS request is to be allowed. DNS security service 315 can determine whether the DNS request is to be allowed, such as based on querying an allow list or a historical dataset of classified domains. If DNS security service 315 determines that the DNS request is to be allowed, at 356, DNS security service 315 provides to firewall 310 an indication that the DNS request is allowed (otherwise, DNS security service 315 can provide an indication that the DNS request is to be disallowed). In response to receiving an indication that the DNS request is not to be allowed (e.g., is to be disallowed), firewall 310 can correspondingly apply a security policy with respect to the DNS request, such as to block the DNS request. Conversely, in response to receiving an indication that the DNS request is to be allowed, at 358, firewall 310 allow the DNS query to reach its destination, a DNS service 320 (e.g., a third party service), to receive a DNS response (e.g., for the information to resolve the domain comprised in the DNS request). At 360, firewall 310 obtains the DNS response from DNS service. Before providing the DNS response to client system 305, firewall 310 can query DNS security service 315 for an indication of whether the DNS response is to be allowed. At 362, firewall 310 provides the DNS response to DNS security service 315. In response to receiving the DNS response, DNS security service 315 can query a dataset of precomputed classifications (e.g., DNS record classifications processed offline or real-time, such as classifications as most recent as the previous day or less than 10 minutes ago). DNS security service 315 determines whether the DNS response should be allowed or disallowed based on the real-time or historical classifications (e.g., the DNS hijacking records dataset 325). In response to determining that the DNS response is to be disallowed (e.g., based on determining that the record was previously classified as a DNS hijacking record), DNS security service 315 can provide an indication to firewall 310 that DNS response is to be disallowed and firewall 310 correspondingly applies a security policy, such as to block or quarantine the DNS response. In response to determining that the DNS response is to be allowed, at 364, DNS security service 315 provides to firewall 310 the indication that the DNS request is to be allowed. In response to firewall 310 receiving an indication that the DNS response is allowed (e.g., that the corresponding record is not a DNS hijacking record), at 366, firewall 310 provides the DNS response to client system 305.

Additionally, in response to receiving the DNS response from firewall at 362, DNS security service 315 causes the DNS record to be classified in real-time. In the example shown, at 364, DNS security service 315 provides the DNS record to real-time detection pipeline 330. DNS security service 315 provides the DNS record to the real-time detection pipeline 330 contemporaneous with DNS security service 315 receiving the DNS record from firewall 310. For example, DNS security service 315 provides the DNS record to the real-time detection module 330 within a few milliseconds of the DNS record being collected/observed (e.g., newly observed).

In some embodiments, real-time detection pipeline 330 performs a pre-filtering. For example, real-time detection pipeline 330 can implement system 400 of FIG. 4 in connection with pre-filtering DNS records to obtain pre-candidate records. The pre-filtering of the DNS records may be based at least in part on one or more of (i) a popularity of the DNS record, (ii) the diversity and number of records seen with the domain in the pre-candidate record, (iii) a determination that a DNS response comprises a new record, (iv) a determination that the DNS response is a newly observed hostname, (v) a determination of whether the DNS record has already been classified as a pre-candidate record.

Real-time detection pipeline 330 can batch DNS records (e.g., the pre-candidate records obtained based on the pre-filtering) before calculating real candidate records. In some embodiments, the DNS records (e.g., the pre-candidate records) are batched according to a predetermined batching period of time (e.g., 1 minute, 2 minutes, 5 minutes, 10 minutes, less than 30 minutes, etc.).

After batching records (e.g., the pre-candidate records), real-time detection pipeline 330 performs candidate selection to determine the records for which real-time DNS record classification is to be performed. After prefiltering and candidate selection, the new DNS records that remain are sent to feature extraction and then the features are sent to a classifier for real-time DNS record classification. For example, the candidate DNS records (e.g., the DNS records obtained based on the candidate selection) are used to extract features for the candidate DNS records and then query a machine learning model to determine whether a particular candidate record is predicted to be a DNS hijacking record.

According to various embodiments, real-time detection pipeline 330 leverages pre-collected data and/or pre-computed data in connection with performing a real-time DNS record classification. In the example shown, real-time detection pipeline 330 obtains data from pre-calculated data dataset 350 and/or pre-calculated subnet history dataset 345 to perform feature extraction for the DNS record classification. The pre-collection and/or pre-computation of data for use in feature extraction for the DNS record classification enables a reduced latency in the classification process, which can thus allow for real-time DNS record classifications.

Real-time detection pipeline 330 can implement a post-filtering to reduce the false positives in the DNS record classifications. In some embodiments, real-time detection pipeline performs the post-filtering with respect to those candidate records that the classifier predicts to be DNS hijacked records. System 300 deems those predicted DNS hijacking records that remain after post filtering to be the DNS hijacking records. These DNS hijacking records are stored in DNS hijacking records dataset 325 to be used as a ground truth of DNS hijacking records.

As further described in connection with FIGS. 4 and 5, according to various embodiments, system 300 uses four parts (e.g., modules) to perform the real-time DNS record classifications: (i) a pre-filtering module, (ii) a batching module, (iii) an offline pre-calculation module, and (iv) a real-time detection module.

FIG. 4 is an illustration of system for pre-filtering DNS records in connection with providing real-time detection of DNS hijacking records according to various embodiments. In some embodiments, system 400 implements process for pre-filtering of collected/observed DNS records to reduce the number of records for which a classifier is to be queried for a real-time DNS classification. In the example shown, system 400 comprises, or otherwise accesses, an allowlist 410 (or other such mapping of DNS records to historical DNS record classifications) and/or pDNS API 430.

According to various embodiments, the system pre-filters DNS records in response to receiving the DNS records, such as from a firewall that intercepted DNS traffic and provided the DNS record for classification. For example, referring to FIG. 3, system 300 (e.g., DNS security service 315) implements the pre-filtering for those records extracted from DNS responses obtained from firewall 310. In some embodiments, the system performs the pre-filtering of DNS records extracted from DNS responses individually right away as the DNS responses are received from the security entity (e.g., the firewall).

System 400 filters the DNS records based on a popularity of the records. For example, at 405, system 400 determines whether the DNS record in the DNS response is popular according to a definition (e.g., has been seen for more than threshold N times over a threshold T time). The very popular records can be deemed to certainly not be hijacking related. Additionally, system 400 may optionally filter DNS records of domains with an extremely large number and diverse set of records. In some embodiments, system 400 uses a listing of popular records with a large number and diverse set of records based on an offline computation of a list of such records. For example, system 400 can compute (or otherwise obtain) the list of these records offline (e.g., once a day or according to another suitable predetermined frequency). System 400 deems the list of popular records to be non-DNS hijacking records because records that have observed (e.g., collected via interception of DNS traffic) at least for a predefined period of time (e.g., for at least four days or other suitable period of time for the record to have sufficient observation or history) with a frequent appearance in a pDNS dataset, for example, on the order of thousands of observations/appearances. Domains with an extremely large number of records across many ISPs, ASNs and countries are difficult to accurately perform DNS record classification to detect DNS hijacking records. Thus, at 405, system filter some of these domains because performing the real-time DNS classification would increase potential false positives and computation time and cost. In contrast, an offline detection pipeline generally does not filter such domains because the computational time and cost is not as critical. In some embodiments, a function is applied to the records in the allowlist to increase the number of records filtered. For example, given a popular record {shop.uk.example.com,A,234.45.66.78} the allowlist would store the root domain and /24 subnet of the IP only, such as {example.com,234.45.66}. And the record observed by the system will be filtered if after applying the same function would match a root and subnet pair in the allowlist.

System 400 filters the DNS records based on a determination of whether a DNS record is a new record. For example, at 415, system 400 determines if the record comprised in, or associated with, a DNS response is a new record (e.g., a new triplet of (rrname, rrdata, rrtype)). System 400 determines whether the DNS record triplet (rrname, rrdata, rrtype) for the record obtained based on the DNS response has been previously observed in the pDNS. For example, system 400 can query a record of pDNS data to determine whether the DNS record has been previously observed. System 400 can use pDNS API 430 to determine whether the DNS record is a new record. System 400 can filter out non-new DNS records (e.g., old records) because such records either (i) were already analyzed a detection pipeline such as an offline pipeline or previously by a real-time detection pipeline, or (ii) have a long history and thus are not considered as candidate records resulting from a DNS hijacking attack.

System 400 filters the DNS records based on a determination of whether a DNS record corresponds to a newly observed hostname (NOHs). For example, at 420, system 400 filters newly observed host names because newly observed hostnames generally do not have sufficient pDNS history to determine whether the DNS records are a result of a DNS hijacking attack. We define NOH as an rrname that we have first seen in pDNS in less than D days, where D is a positive integer (e.g., d=30). D may be configurable, such as to modify the sensitivity of the pre-filtering. This is one parameter where we consider a higher d for the real-time detector compared to the offline detector thus filtering more records. System 400 filters out those DNS records deemed to correspond to a NOH.

For DNS records that are not deemed to correspond to a NOH at 420, system 400 uses the DNS record to perform a pre-candidate selection at 425. In some embodiments, the pre-candidate selection process is a lightweight candidate selection. For example, system 400 determines whether the IP of the DNS record (e.g., the new DNS record) has been observed for the root domain of the rrname in the DNS record. In response to determining that the IP of the DNS record has not been observed for the root domain of the rrname in the DNS record, system 400 deems the DNS record as a pre-candidate record. System 400 can output the pre-candidate record, or an indication that the DNS candidate is a pre-candidate record, such as by providing the DNS record to a matching module/service or another module in a real-time detection pipeline. In some embodiments, system 400 additionally determines whether the IP of the new DNS record and any of its subdomains of the root domain of the rrname in the DNS record has been observed together, and if the IP address in the DNS record has been observed with any of the subdomains of the root rrname in the DNS record, then DNS record is deemed not to be a pre-candidate record.

According to various embodiments, system 400 implements a pDNS API to obtain (e.g., query) pDNS data. The pDNS API is configured to efficiently query historical pDNS data. As an example, the pDNS data is stored in a wide-column, key-value NoSQL database (e.g., BigTable) with millisecond-level latency. The database (e.g., BigTable) is configured for fast key-based lookup, however it is not efficient for complex aggregation jobs needed for feature calculation. Various embodiments thus implement recalculation and additional innovative techniques to exactly calculate features. The system implements a ingestion pipeline that is configured to continuously update pDNS data from upstream sources (e.g., customer traffic and third party sources), typically within a few hours of delay. Upon receiving a query for a given domain, the API provides resource records related to the domain and includes the first_seen and last_seen observed time of the resource records, along with daily counts from the past 30 days. Accordingly, the pDNS API supports the detection of whether the hostname or the record is newly observed or a record is a pre-candidate record.

FIG. 5 is an illustration of a system for providing real-time detection of DNS hijacking records according to various embodiments. According to various embodiments, system 500 is implemented at least in part by system 100 of FIG. 1. System 500 implements processes 600-1000 of FIGS. 6-10.

System 500 is configured to provide real-time detection of DNS hijacking records. In some embodiments, system 500 determines whether a DNS record (e.g., a DNS record intercepted by an inline firewall, which provide the DNS record to system 500) is a result of a DNS hijacking attack (e.g., that the DNS record is a DNS hijacking record). System 500 provides the detection of whether a DNS record is a DNS-hijacked record in a period of time suitable for real-time detection, such as less than 1 hours. In some embodiments, system 500 provides the real-time detection of DNS hijacking records within 30 minutes, and preferably within 15 minutes, of the DNS record first being observed (e.g., intercepted by a security entity for an enterprise network). During the time period between when system 500 obtains a DNS record. The DNS record may be permitted to pass (e.g., the inline security entities may handle the DNS traffic as benign). Upon system 500 providing a DNS record classification, system 500 can cause a security service (e.g., one or more security entities) to handle future such DNS records according to the DNS record classification. For example, if the DNS record is deemed a DNS hijacking record, system 500 causes the security service to handle the DNS hijacking record in the future according to a security policy (e.g., to block or quarantine such DNS traffic).

In the example shown, system 500 comprises offline pre-calculation module 530 and real-time detection module 540. In some embodiments, system 500 additionally comprises prefiltering module 510 and/or batching module 520.

According to various embodiments, system 500 is implemented as a real-time DNS hijacking detection pipeline. In some embodiments, DNS records received by system 500 go through a prefiltering process (e.g., are analyzed by prefiltering module 510) to decrease the number of records to be processed. The prefiltering of received DNS records can improve processing cost and time. In response to the DNS records being pre-filtered, the resultant DNS records are batched for more effective handling, such as to improve (e.g., decrease) the cost of performing the real-time DNS record classification for the DNS record. As an example, system 500 implements batching module 520 to batch pre-candidate DNS records obtained from (e.g., output by) prefiltering module 510. Batched DNS records are provided to a real-time detection pipeline that performs a DNS record classification process. For example, system 500 provides batches of DNS records to real-time detection module 540 to determine corresponding DNS record classifications (e.g., to detect DNS hijacking records). System 500 can implement an offline pre-calculation technique that enables a quicker and more cost effective real-time DNS record classification (e.g., real-time DNS hijacking record detection). System 500 may implement offline pre-calculation module 530 to perform the offline pre-calculation technique.

System 500 can use prefiltering module 510 to prefilter DNS records to obtain pre-candidate records for which real-time DNS record classification is to be performed. Prefiltering module 510 can receive DNS records to be analyzed. For example, prefiltering module 510 receives DNS records from a security service or one or more security entities (e.g., inline firewalls) associated with the security service. The security service or the associated security entities may monitor/intercept traffic (e.g., DNS traffic across one or more enterprise networks). According to various embodiments, prefiltering module is implemented by system 400 of FIG. 4.

In response to receiving DNS records (e.g., from DNS responses intercepted by a security service), prefiltering module 510 can promptly/immediately process the DNS records in connection with system 500 providing real-time DNS record classification. Prefiltering module 510 identifies pre-candidate records and outputs an indication of such pre-candidate records for further processing in connection with the real-time DNS record classification.

System 500 uses batching module 520 to batch DNS records for which real-time DNS record classification is to be performed (e.g., the DNS records to be input to real-time detection module 540). Batching module 520 can collect observed DNS records (e.g., the pre-candidate records) in batches, such as over a predetermined period of time (e.g., 1 minute, 2 minutes, 5 minutes, 10 minutes, less than 30 minutes, etc.). Because system 500 processes large datasets in connection with performing the DNS record classification, it is computationally much cheaper if DNS records to be analyzed are batched and processed (e.g., fed into real-time detection module 540) together (e.g., for contemporaneous or simultaneous record classification). In some embodiments, system 500 determines DNS record classification in batches in connection with providing real-time detection of DNS hijacking records (e.g., DNS record classifications contemporaneous with the interception or handling of traffic). The predetermined period of time may be less than 3 hours, 1 hour, 30 minutes, and preferably less than 10 minutes. The batching module collects DNS records for a predefined period of time (e.g., one minute or other suitable time to enable real-time DNS hijacking record detection). After the batching module 520 sends the collected DNS records for real-time DNS record classification (e.g., to the real-time detection module 540) in batches.

According to various embodiments, system 500 leverages pre-collection and/or pre-calculation of certain data used in connection with the real-time record classification. Collecting data from third party services and/or computing data, such as features for ML-based classification, typically takes a lot of time and makes the real-time DNS record classification infeasible if the collection and computation of such data is similarly performed in real-time. For example, the prefiltering module 510 and batching module 520 are lightweight and run really fast (e.g., on the order seconds). However, the real-time DNS record classification (e.g., the analysis of a DNS record, or batch of DNS record, using real-time detection module 540) would be very slow (e.g., on the order hours) and expensive if certain data collection and computation was performed contemporaneous with (e.g., in real-time) with the DNS record classification. Without the offline collection and/or pre-calculation of certain data (e.g., by offline pre-calculation module 530), the real-time detection module 540 would be unable to provide a DNS record classification (e.g., real-time DNS hijacking record detection) in real-time (e.g., within an hour, or more preferably in less than 30 minutes, or such shorter time period) because the pDNS history of records (e.g., all the pDNS records) are considered for processing after batching.

According to various embodiments, in connection with pre-calculating the data, offline pre-calculation module 530 collects data, such as pDNS data, geolocation data, and other data that may be used in the real-time DNS record classification.

Offline pre-calculation module 530 pre-calculates data, such as pDNS data, for real-time candidate selection. In some embodiments, pre-calculating the data (e.g., the pDNS data) comprises filtering by rrtype used, removing invalid records, removing unnecessary fields, pre-calculating new fields used (e.g., subnet of IPs) for candidate selection, and/or partitioning data for faster search by root domain. In some embodiments, offline pre-calculation module 530 pre-calculates the data at a lower frequency than real-time detection module 540 performs DNS record classification. For example, offline pre-calculation module 530 can update the pre-collected data and pre-compute the corresponding data daily. As another example, offline pre-calculation module 530 can update the pre-collected data and pre-compute the corresponding data at predetermined time intervals greater than 12 hours, etc.

In addition, offline pre-calculation module 530 pre-calculates data used in feature extraction. Offline pre-calculation module 530 can pre-compute data that is used by real-time detection module 540 to perform candidate record selection or feature extraction. Additionally, or alternatively, offline pre-calculation module 530 can pre-compute data that makes it faster to compute features used by the classifier (e.g., ML model 544) to generate a predicted DNS record classification.

In some embodiments, offline pre-calculation module 530 pre-calculates pDNS data similar to the case of the pre-calculation for candidate selection.

In some embodiments, offline pre-calculation module 530 pre-calculates intermediate versions of one or more of (i) a feature(s) per root domains, and (ii) a feature(s) per IP address. The pre-calculated information can then be used to more efficiently calculate features at the real-time feature extraction step (e.g., at feature extraction service 542).

In the example shown, offline pre-calculation module 530 pre-collects pDNS data and stores the pDNS data in the pDNS dataset 532, and pre-collects geolocation data and stores the geolocation data in geolocation dataset 533. Offline pre-calculation module 530 uses the pre-collected pDNS data to extract pDNS subnet history. For example, pDNS subset history extraction service 531 extracts the pDNS subnet history and stores the subnet history in subnet history dataset 536. Offline pre-calculation module 530 also uses the pre-collected pDNS data and/or geolocation data to perform feature and data pre-calculation. For example, feature and data pre-calculation service 534 pre-calculates certain data (e.g., certain intermediate features) and stores the pre-calculated data in precalculated dataset 535.

According to various embodiments, offline pre-calculation module 530 uses real-time detection module 540 to perform real-time DNS hijacking record detection. Real-time detection module 540 is configured to perform real-time DNS record classification, such as within 10 minutes. In some embodiments, real-time detection module 540 performs the DNS record classification in a time period that is greater than 100 ms and less than 10 minutes. For example, real-time detection module 540 performs the DNS record classification within 5 minutes of the corresponding DNS record being first observed (e.g., intercepted by a security entity and provided to system 500 for classification, etc.).

System 500 inputs batches of DNS records (e.g., pre-candidate records identified by prefiltering module 510) from batching module 520. In the example shown, real-time detection module 540 is configured to perform a candidate selection process. For example, pre-candidate records from a current batch are input to 541 and real-time detection module 540 performs candidate selection. At 541, the current batch of DNS records is passed to a candidate selection process (or service that implements a candidate selection process) to determine the candidate records to be evaluated (e.g., the records for which the DNS record classification is to be generated).

In the example shown, the candidate selection process leverages the precalculated subnet history (e.g., subnet history data obtained from the subnet history dataset 536). In the case of DNS records that are A records (IP addresses), the candidate selection process comprises checking whether the /24 subnets of the IP addresses match any of the /24 subnets in the history of the root domain (and all of its subdomains) of the rrname in the particular DNS record. If real-time detection module 540 determines that a subnet in the root domain's history then real-time detection module 540 deems the particular DNS record to not be a candidate record (e.g., a candidate DNS hijacking record). For example, as illustrated, DNS records deemed not to be a candidate record are filtered out. Otherwise, real-time detection module 540 deems the new records as candidate records. For other types of DNSs record candidate selection is the same as for an A record but instead of calculating the /24 subnet of IP addresses a function f is applied to the rrdata in the record. Function f, for example, could be calculating the subnet for an IP address, calculating the root domain for a mail server or name server domain, or calculating a hash of the text for text based records.

Real-time detection module 540 implements a feature extraction with respect to those DNS records that are deemed to be candidate records (e.g., candidate DNS hijacking records). For example, real-time detection module 540 provides the output of 541 to a feature extraction service to perform feature extraction. As shown, at 542, real-time detection module 540 performs feature extraction with respect to the candidate records.

In some embodiments, the feature extraction process implements pre-calculated data, such as pre-computed intermediate features, in connection with performing feature extraction. Real-time detection module 540 determines (e.g., extracts, calculates, etc.) features for the candidate records by leveraging the precalculated data for efficiency. For example, as shown, the feature extraction includes obtaining pre-calculated data in precalculated dataset 535.

Examples of the features extracted based at least in part on the pDNS data are provided in Tables 1 and 2 below. In response to performing feature extraction, the system passes the extracted features to a machine learning (ML) model that predicts the verdict (e.g., the ML model generates a prediction that corresponds to a likelihood that the domain is a DNS hijacked domain).

According to various embodiments, the system extracts four types or groups of features. For example, the system extracts the four types/groups of features from the information pertaining to the candidate domains. Three groups of features pertain to the statistics of the historical and new IP addresses and one group of features pertains to the features of the domain.

In some embodiments, the system standardizes the features, such as by removing the mean and scaling the data to unit variance. The system can then use the extracted standardized features as an input to a machine learning model to predict the class of the (rrname, rrtype, rrdata) triplets (e.g., to classify the record). Tables 1 and 2 provide examples of features that may be implemented. The system may implement all or any combination of the features listed in Tables 1 and 2. Additionally or alternatively, the system may implement other features or types of features. As an example, the statistics pertaining to certain characteristics or values can refer to one or more of the average, minimum, maximum, and standard deviation, and/or other similar types of statistical measures. The system queries a machine learning classifier to classify A records (e.g., to predict whether the domain is a DNS hijacked domain based on the A records), and query another machine learning model based on a set of other features to classify NS records or other record types (e.g., to predict whether the domain is a DNS hijacked domain based on the NS records).

TABLE 1
Examples of IP features

| Feature | | |
|---|---|---|
| Category | Feature | Description |
| Statistics | Statistics pertaining to the number of | Statistics of |
| for the | root domains per IP | previously |
| Previous IP | Statistics pertaining to the number of | used IP |
| | Top Level Domains (TLDs) per IP | |
| | Statistics pertaining to the resource | |
| | record age per IP | |
| | Statistics pertaining to the proportion | |
| | of domains per IP that are malicious | |
| Statistics for | Number of root domains using IP in new | |
| the New IP | resource record | |
| (the IP | Number of TLDs among root domains | Statistics |
| rrdata that | using IP in new resource record | of IP in |
| is potentially | Average age of resource records where | the new |
| hijacking) | new IP is in rrdata field | resource |
| | Proportion of domains using the IP in the | record |
| | new resource record that are malicious | |
| | Number of root domains that started | |
| | using the IP in the new resource record | |
| | in the past N days (where N is a | |
| | predefined positive integer) | |
| | Country Code of a particular IP address | |
| | (CC) matches domain TLD | |
| | IP is in an Autonomous System Number | |
| | (ASN) not used previously by domain | |
| | IP is in an country not used previously | |
| | by domain | |
| | IP is in an Internet Service Provider | |
| | (ISP) not used previously by domain | |
| | IP is in a subregion not used previously | |
| | by domain. | |
| | A subregion is an area within a larger | |
| | region that can contain multiple | |
| | countries. (e.g., Central Asia) | |
| IP Statistics | Statistics of the difference between | Comparison of |
| Comparison | historical IPs and new IP in the | statistics of |
| | number of root domains per IP | previously |
| | Statistics of the difference between | used IPs and |
| | historical IPs and new IP in the | IP in new |
| | number of TLDs per IP | resource record |
| | Statistics of the difference between | |
| | historical IPs and new IP in the | |
| | average resource record age per IP | |
| | Statistics of the difference between | |
| | historical IPs and new IP in the | |
| | proportion of domains per IP that are | |
| | malicious | |
| | Statistics of the difference between | |
| | historical IPs and new IP in the | |
| | integer value of the IPs | |
| Domain | Number of new root domains seen in | |
| Features | the domain's nameserver (NS) records | |
| | in the past N days (where N is a | |
| | predefined positive integer) | |
| | Number of new IPs seen in the domain's | |
| | A records in the past N days (where N | |
| | is a predefined positive integer) | |
| | Number of new ISPs associated with new | |
| | IPs seen in the domain's A records | |
| | in the past N days (where N is a | |
| | predefined positive integer) | |
| | Number of new subregions associated | |
| | with new IPs seen in the domain's | |
| | A records in the past N days (where N | |
| | is a predefined positive integer) | |
| | Number of new RRs for the domain seen | |
| | in the past N days (where N is a | |
| | predefined positive integer) | |
| | Number of rrtypes in new resource | |
| | records | |
| | Age of domain | |
| | Number of subdomains for the domain | |
| | Number of IPs used by the domain | |
| | Number of /24 subnets of IPs used by | |
| | the domain | |
| | Number of ISPs of IPs used by the | |
| | domain | |
| | Number of countries of IPs used by | |
| | the domain | |
| | Number of subregions of IPs used by | |
| | the domain | |
| | Number of ASNs of IPs used by the | |
| | domain | |
| | Number of IPs used by domain with | |
| | a geolocation that matches the domain's | |
| | top level domain (TLD) | |
| | Number of nameservers used by the | |
| | domain | |
| | Number of nameservers' root domains | |
| | used by the domain | |
| | Number of nameservers used by the | |
| | domain that are self-hosted (root | |
| | domain of nameserver matches the root | |
| | domain of target) | |
| | Determination of whether TLD a ccTLD | |

TABLE 2
Examples of Nameserver features

| Feature | | |
|---|---|---|
| Category | Feature | Description |
| Statistics | Statistics pertaining to the number | Statistics of |
| for the | of root domains per nameserver | previously |
| Previous | Statistics pertaining to the number | used |
| Nameserver | of TLDs pe rnameserver | nameservers |
| | Statistics pertaining to the average | |
| | resource record age per nameserver | |
| | Of all previous nameservers, statistics | |
| | pertaining to the number of domains | |
| | using the nameserver whose root domain | |
| | matches that of the nameserver | |
| | Of all previous nameservers, statistics | |
| | pertaining to the number of domains | |
| | using the nameserver whose | |
| | TLD matches that of the nameserver | |
| | Statistics pertaining to the proportion | |
| | of the nameservers per nameserver's | |
| | root domain that are malicious | |
| | Statistics pertaining to the proportion | |
| | of domains per nameserver's root | |
| | domain that are malicious | |
| Statistics | Number of root domains using the | Statistics of |
| for new | new nameserver | nameserver |
| nameserver | Number of TLDs among root domains | in the new |
| (the name | using the new nameserver | resource |
| server | Average age of resource records | record |
| rrdata | where the new nameserver is in | |
| that is | rrdata field | |
| potentially | Proportion of domains using the | |
| hijacking) | new nameserver that are malicious | |
| | Number of root domains that started | |
| | using the new nameserver in the past | |
| | N days (where N is predefined | |
| | positive integer) | |
| | For the new nameserver average number | |
| | of domains using the nameserver whose | |
| | root domain matches that of the new | |
| | nameserver | |
| Nameserver | Statistics of difference between the | Comparison of |
| Statistics | number of root domains per nameserver | statistics of |
| Comparison | of the previously used nameservers and | previously |
| | the nameserver in new resource record | used |
| | Statistics of difference between the | nameservers |
| | number of TLDs per nameserver of the | and |
| | previously used nameservers and the | nameserver in |
| | nameserver in new resource record | new resource |
| | Statistics of difference between the | record |
| | average resource record age per | |
| | nameserver of the previously used | |
| | nameservers and the nameserver in new | |
| | resource record | |
| | Statistics of difference of the number | |
| | of domains whose root domain matches | |
| | that of their nameserver's root | |
| | domain between the previously used | |
| | nameservers and the nameserver in | |
| | new resource record | |
| | Statistics of difference of the | |
| | number of domains whose TLD matches | |
| | that of their nameserver's TLD | |
| | between the previously used nameservers | |
| | and the nameserver in new resource | |
| | record | |
| | Statistics of difference of proportion | |
| | of the nameservers per nameserver | |
| | root domain that are malicious between | |
| | the previously used nameservers and | |
| | the nameserver in new resource record | |
| | Statistics of difference of the | |
| | proportion of domains per nameserver | |
| | root domain that are malicious between | |
| | the previously used nameservers and | |
| | the nameserver in new resource record | |
| Domain | Number of new root domains seen in | |
| Features | the domain's nameserver records in | |
| | the past N days (where N is predefined | |
| | positive integer) | |
| | Number of new IPs seen in the domain's | |
| | A records in the past N days (where N | |
| | is predefined positive integer) | |
| | Number of new ISPs associated with | |
| | new IPs seen in the domain's A | |
| | records in the past N days (where | |
| | N is predefined positive integer) | |
| | Number of new countries associated | |
| | with new IPs seen in the domain's A | |
| | records in the past N days (where | |
| | N is predefined positive integer) | |
| | Number of new subregions associated | |
| | with new IPs seen in the domain's A | |
| | records in the past N days (where | |
| | N is predefined positive integer) | |
| | Number of resource records for | |
| | the domain seen for the first time | |
| | in the past N days (where N is | |
| | predefined positive integer) | |
| | Number of rrtypes in new resource | |
| | records | |
| | Age of domain | |
| | Number of subdomains for the domain | |
| | Number of IPs used by domain | |
| | Number of /24 subnets of IPs used | |
| | by the domain | |
| | Number of ISPs of IPs used by domain | |
| | Number of countries in which IPs | |
| | used by domain are located | |
| | Number of subregions in which IPs | |
| | used by domain are located | |
| | Number of IPs used by domain with | |
| | a geolocation that matches the TLD | |
| | for the domain | |
| | Number of nameservers used by the | |
| | domain | |
| | Number of root domains of nameservers | |
| | used by the domain | |
| | Number of nameservers used by the | |
| | domain that are self-hosted (root | |
| | domain of nameserver matches the | |
| | root domain of target) | |
| | TLD is a ccTLD | |

In response to extracting the features for the candidate record(s), real-time detection module 540 provides the extracted features to a prediction engine that predicts whether a candidate record is a DNS hijacking record, or otherwise determines a likelihood that the candidate record is a DNS hijacking record. In the example shown at 543, the prediction of whether the candidate record(s) is a DNS hijacking record is performed based at least in part on the extracted features and ML model 544. The prediction engine can query the ML model 544 based at least in part on the extracted features to obtain a predicted DNS record classification.

ML model 544 is a classifier trained based on a machine learning process. Examples of machine learning processes that can be implemented in connection with training the classifier(s) include random forest, support vector machine, naive Bayes, logistic regression, K-nearest neighbors (KNN), decision trees, gradient boosted decision trees, a neural network (NN), etc.

ML model returns a predicted DNS record classification, such as in the form of a likelihood that the candidate record is a DNS hijacking record or a non-DNS hijacking record. According to various embodiments, the real-time detection module 540 determines whether the candidate record is a predicted DNS hijacking record based on the likelihood that the candidate record is a DNS hijacking record returned by ML model 544. As illustrated, at 545, real-time detection module 540 filters out candidate records that are not deemed to be predicted candidate DNS hijacking records, and otherwise continues to process those candidate records deemed to be predicted candidate DNS hijacking records. For example, if the likelihood is larger than a predefined threshold, then real-time detection module 540 deems the candidate record to be a predicted DNS hijacking record. The predefined threshold may be configurable, such as to adjust the precision recall tradeoff of the prediction engine/classifier.

Because hijacked records can sometimes exhibit similar behavior to normal records, in some embodiments, the system uses auxiliary information such as web crawls, WHOIS, and zone files information to perform a post filtering to decide if a record is truly hijacked.

In some implementations, the post-filtering technique comprises two steps. In the first step, the system crawls the websites of the domain in the record real-time using both a most recent historical IP address and the IP address in the predicted hijacking record. Then the system performs a comparative analysis of the web contents (and, according to some embodiments, the certificates) hosted on the hijacked address and the original address. If the content (or, according to some embodiments, the certificate) is the same on both IP addresses, then the system concludes that the new record is not a hijacked record. In the second step, if the collected WHOIS data indicates that the domain is newly registered or that the ownership recently changed, then the system (e.g., the DNS hijacking record detection pipeline) will not consider the record as hijacked (e.g., the DNS record will not be deemed to have been a result of a DNS hijacking attack).

Offline, the system uses a length of time over which the rrdata of a new record persists to filter the verdicts. If the rrdata of a new record persists over a duration of time (e.g., more than a threshold period of time), the classification for the DNS hijacking record is changed to indicate that the record is benign. The system uses the length of time over which rrdata of a new record is persisted to filter the verdicts because of the generally short-lived nature of a DNS hijacking attack.

Real-time detection module 540 collect auxiliary data about the predicted DNS hijacking records. Examples of auxiliary data that can be used to post-filter the ML-based classifications include customer traffic logs, WHOIS data, web crawl data, etc. Various other types of auxiliary data may be implemented. In the example shown, at 546, for candidate records deemed to be predicted DNS hijacking records, real-time detection module 540 collects WHOIS data. Similarly, at 547, real-time detection module 540 collects web crawled data. At 548, real-time detection module 540 performs a post-filtering of the predicted candidate DNS hijacking records based at least in part on the WHOIS data and the web crawl data. For example, real-time detection module 540 can use WHOIS data to decide if the root domain changed owners recently indicating that the predicted DNS hijacking record is not a true DNS hijacking record. As another example, real-time detection module 540 can use web crawl data based at least in part on first collecting the two most recent historical rrdata fields (r0 and r1) of the rrname that came before the predicted DNS hijacking record (rh). Real-time detection module 540 can then obtain web crawl data for the rrname three times by visiting the IPs r0, r1 and rh. From this web-crawling, real-time detection module 540 obtains web contents (w0, w1, wh) and certificates (c0, c1, ch). If wh matches any of w0 or w1, real-time detection module 540 determines that the predicted DNS hijacking record is not a true DNS hijacking record and the corresponding predicted DNS hijacking record is filtered out. Additionally, or alternatively, if real-time detection module 540 determines that ch matches any of c0 or c1, then real-time detection module 540 determines that the predicted DNS hijacking record is not a true DNS hijacking record and the corresponding predicted DNS hijacking record is filtered out. Otherwise, the real-time detection module 540 determines the corresponding candidate record to be a DNS hijacking record. For example, if real-time detection module 540 determines, based on the collected WHOIS data or web crawl data, that a predicted DNS hijacking records is not filtered, then real-time detection module 540 adds the predicted DNS hijacking record to a list of DNS hijacking records.

In some embodiments, the real-time DNS record classifications (e.g., the indications of DNS records that are DNS hijacking records, or DNS records that are non-DNS-hijacked records) can be used by a security service that handles network traffic (e.g., DNS traffic) based at least in part on the real-time DNS record classifications. For example, a security service uses the DNS record classifications to block records (e.g., DNS traffic) for customers by identifying DNS traffic comprising DNS records that have been classified as DNS hijacking records and correspondingly handling (e.g., blocking, etc.) such DNS traffic.

FIG. 6 is a flow diagram of a method for providing real-time detection of DNS hijacking records according to various embodiments. In some embodiments, process 600 is implemented at least in part by system 100 of FIG. 1, system 300 of FIG. 3, and/or system 500 of FIG. 5. Process 600 may be implemented by a system providing security service to an inline security entity, such as to a firewall (e.g., a next generation firewall).

At 605, the system filters a set of DNS records in real-time and stores an indication of a set of resultant filtered DNS records. At 610, the system detects DNS hijacking records based at least in part on processing a batch of resultant filtered DNS records. At 615, the system performs an active measure. The active measure may include handling the DNS records, such as blocking DNS traffic comprising the DNS records. Additionally, or alternatively, the active measure may include publishing an allowlist of DNS records classified as non-DNS hijacking records, and/or a denylist of DNS records classified as DNS hijacking records. At 620, a determination is made as to whether process 600 is complete. In some embodiments, process 600 is determined to be complete in response to a determination that no further DNS records are to be analyzed or classified, no further DNS records are obtained, no further classifications are to be generated for candidate records, no further traffic is to be classified, an administrator indicates that process 600 is to be paused or stopped, etc. In response to a determination that process 600 is complete, process 600 ends. In response to a determination that process 600 is not complete, process 600 returns to 605.

FIG. 7 is a flow diagram of a method for obtaining a real-time detection of a DNS classification for a batch of DNS records according to various embodiments. In some embodiments, process 700 is implemented at least in part by system 100 of FIG. 1, system 300 of FIG. 3, and/or system 500 of FIG. 5. Process 700 may be implemented by a system providing security service to an inline security entity, such as to a firewall (e.g., a next generation firewall).

At 705, the system obtains an indication to process a batch of resultant filtered DNS records.

At 710, the system selects a DNS record from a batch of resultant filtered DNS records.

At 715, the system determines whether a particular record is a candidate record for DNS hijacking.

In response to determining that the particular record is not a candidate record for DNS hijacking, process 700 proceeds to 735. Conversely, in response to determining that the particular record is a candidate record for DNS hijacking, process 700 proceeds to 720.

At 720, the system generates a set of features for the candidate for DNS hijacking classification.

At 725, the system queries a classifier based at least in part on the set of features.

At 730, the system obtains a predicted classification from the classifier. For example, the predicted classification is a prediction of whether the DNS record is a DNS hijacking record.

At 735, the system determines whether another DNS record(s) in the batch is to be processed. In response to determining that another DNS record(s) in the batch is to be processed, process 700 returns to 710 and process 700 iterates over 710-735 until no further DNS records in the batch are to be processed. In response to determining that no further DNS records in the batch are to be processed, process 700 proceeds to 740.

At 740, the system provides the predicted classification(s) for the batch of resultant filtered DNS records. In some embodiments, the system stores the predicted classifications for the batch (e.g., the DNS record classifications for the DNS records in the batch) in a DNS hijacking records dataset or DNS record classification dataset. The system can update an allowlist (e.g., a list of permitted DNS records such as non-DNS hijacking records) or a denylist (e.g., a list of restricted DNS records, such as DNS hijacking records). Additionally, the system may provide an indication of the DNS record classification, such as by publishing (e.g., pushing) an allowlist (e.g., non-DNS hijacking records) or a denylist (e.g., DNS hijacking records) to security entities for enforcement of a security policy. In some embodiments, the system provides the indication to the security entity that intercepted the DNS traffic and provided the DNS request and/or DNS response to the system. The system may additionally provide the indication to other security entities.

At 745, a determination is made as to whether process 700 is complete. In some embodiments, process 700 is determined to be complete in response to a determination that no further batches of DNS records are to be analyzed or classified, no further DNS records are to be analyzed or classified, no further DNS records are obtained, no further classifications are to be generated for candidate domains, no further traffic is to be classified, an administrator indicates that process 700 is to be paused or stopped, etc. In response to a determination that process 700 is complete, process 700 ends. In response to a determination that process 700 is not complete, process 700 returns to 705.

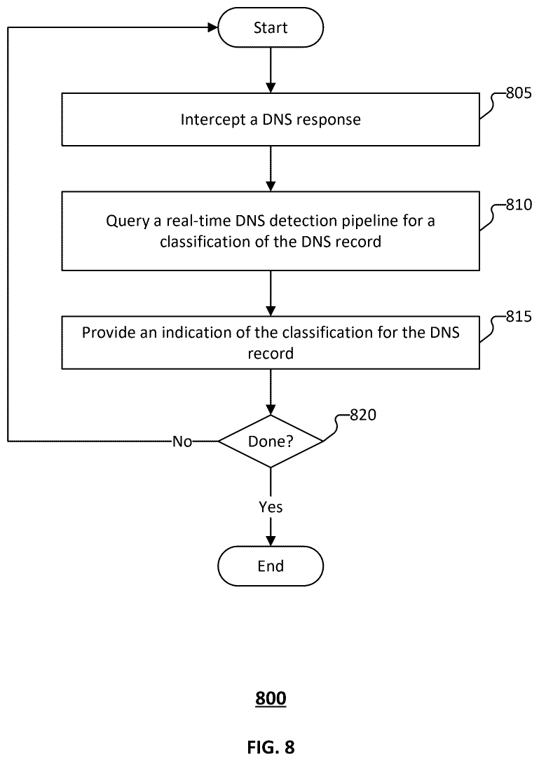

FIG. 8 is a flow diagram of a method for handling a DNS request and corresponding DNS response according to various embodiments. In some embodiments, process 800 is implemented at least in part by system 100 of FIG. 1, system 300 of FIG. 3, and/or system 500 of FIG. 5. Process 800 may be implemented by a system providing security service to an inline security entity, such as to a firewall (e.g., a next generation firewall).

At 805, the system intercepts a DNS response. For example, the system obtains the DNS response that the security entity had received after receiving the indication from the system that the DNS request was to be allowed. The security entity can forward to the system the DNS response received from the DNS service before the security entity returns the DNS response to the node from which the DNS request was sent/originated.

At 810, the system queries a real-time DNS detection pipeline for a classification of the DNS record. For example, the system determines the DNS record from the DNS response and queries the real-time DNS detection pipeline based on the DNS record. In some embodiments, the real-time DNS detection pipeline comprises a classifier, such as a machine learning model.

The DNS detection pipeline is configured to provide a classification for a particular DNS record. In some embodiments, the DNS detection pipeline is configured to provide a classification for a particular DNS record within 12 hours of the DNS record being observed/collected (e.g., within 12 hours of the security entity intercepting the DNS traffic). In some embodiments, the DNS detection pipeline is configured to provide a classification for a particular DNS record within 1 hour of the DNS record being observed/collected. More preferably, the detection pipeline may be configured to provide a classification for a particular DNS record in less than 30 minutes of the DNS record, such as in less than 15 minutes of the DNS record being observed/collected, or between 1 minute and 5 minutes of the DNS record being observed/collected.

In some embodiments, the DNS detection pipeline classifies the DNS record contemporaneously with the interception/handling of DNS traffic with respect to the particular DNS record. In some embodiments, the DNS detection pipeline is configured to provide the classification for the particular DNS record within a time period that is greater than 100 ms of the DNS record being observed/collected and that is less than 30 minutes of the DNS record being observed/collected.

According to various embodiments, the system is configured to (a) permit a DNS record (e.g., a DNS response comprising the DNS record) for a first observation/collection of the DNS record, (b) query the DNS detection pipeline for a DNS record classification (e.g., a classification of whether the DNS record is a DNS hijacking record) in response to the first observation/collection of the DNS record, and (c) cause the DNS traffic for such DNS record to be handled according to a security policy based on the DNS record classification after obtaining the DNS record classification (e.g., from the DNS detection pipeline). In response to obtaining a DNS record classification indicating that the DNS record is not a DNS hijacking record, the system can cause the DNS record (e.g., DNS traffic for the DNS record) to be permitted. In response to obtaining a DNS record classification indicating that the DNS record is a DNS hijacking record, the system can cause the DNS record (e.g., DNS traffic for the DNS record) to be blocked, such as by updating a denylist of DNS records and providing the denylist to a security entity that intercepts and handles traffic such as the DNS traffic (e.g., a security entity that enforces a security policy).

At 815, the system provides an indication of the classification for the DNS record. For example, the system provides the indication of the classification to the process, system, or service that invoked process 800. In some embodiments, the system provides the indication to the security entity that intercepted the DNS traffic and provided the DNS record to the system. The system may additionally provide the indication to other security entities. For example, the system can update a denylist (e.g., a list of restricted DNS records, such as DNS hijacking records).

At 820, a determination is made as to whether process 800 is complete. In some embodiments, process 800 is determined to be complete in response to a determination that no further DNS records are to be analyzed or classified, no further DNS records are obtained, no further classifications are to be generated for candidate domains, no further traffic is to be classified, an administrator indicates that process 800 is to be paused or stopped, etc. In response to a determination that process 800 is complete, process 800 ends. In response to a determination that process 800 is not complete, process 800 returns to 805.

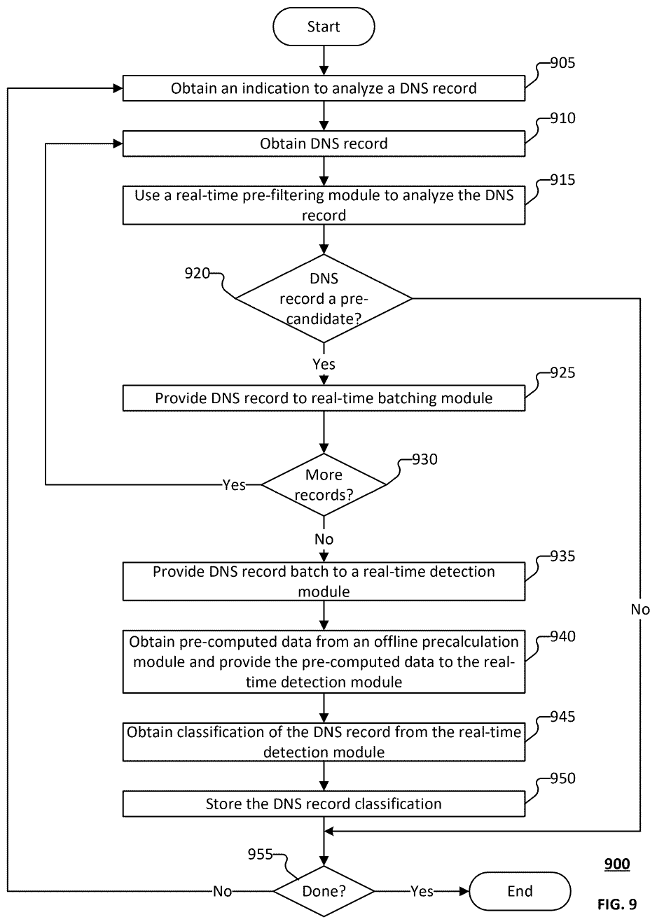

FIG. 9 is a flow diagram of a method for classifying one or more DNS records according to various embodiments. In some embodiments, process 900 is implemented at least in part by system 100 of FIG. 1, system 300 of FIG. 3, and/or system 500 of FIG. 5. Process 900 may be implemented by a system providing security service to an inline security entity, such as to a firewall (e.g., a next generation firewall).

At 905, the system obtains an indication to analyze a DNS record.

At 910, the system obtains a DNS record.

At 915, the system uses a real-time pre-filtering module to analyze the DNS record.

At 920, the system determines whether the DNS record is a pre-candidate (e.g., a pre-candidate DNS record). In response to determining that the DNS record is not a pre-candidate, process 900 proceeds to 955. Conversely, in response to determining that the DNS record is a pre-candidate, process 900 proceeds to 925.

At 925, the system provides the DNS record to a real-time batching module. For example, the system stores the DNS record in a queue for DNS record classification. The system can process DNS record classification in batches, such as batches of DNS records observed/collected (e.g., newly observed) over a predetermined time period. The predetermined time period may be 1 minute, 5 minutes, 10 minutes, or another suitable time period to provide a real-time classification.

At 930, the system determines whether additional records are to be observed/collected or stored in a queue. For example, the system determines whether a batch is full or whether a predetermined period of time for collecting DNS records to be batch-processed has elapsed. In response to determining that additional records are to be observed/collected or stored in the queue (e.g., the current batch), process 900 returns to 910 and process 900 iterates over 910-930 until no additional records are to be observed/collected for the queue (e.g., the current batch). In response to determining that no additional records are to be observed/collected or stored in the queue (e.g., the current batch), process 900 proceeds to 935.

At 935, the system provides the DNS record batch to a real-time detection module.

At 940, the system obtains pre-computed data from an offline pre-calculation module and provides the pre-computed data to the real-time detection module.

At 945, the system obtains a classification(s) of the DNS record(s) from the real-time detection module. For example, the system obtains DNS record classifications for the DNS records within the batch.

At 950, the system stores the DNS record classification(s). Additionally, the system may provide an indication of the DNS record classification, such as by publishing (e.g., pushing) an allowlist (e.g., non-DNS hijacking records) or a denylist (e.g., DNS hijacking records) to security entities for enforcement of a security policy.

At 955, a determination is made as to whether process 900 is complete. In some embodiments, process 900 is determined to be complete in response to a determination that no further DNS records are to be analyzed or classified, no further DNS records are obtained, no further classifications are to be generated for candidate domains, no further traffic is to be classified, an administrator indicates that process 900 is to be paused or stopped, etc. In response to a determination that process 900 is complete, process 900 ends. In response to a determination that process 900 is not complete, process 900 returns to 905.

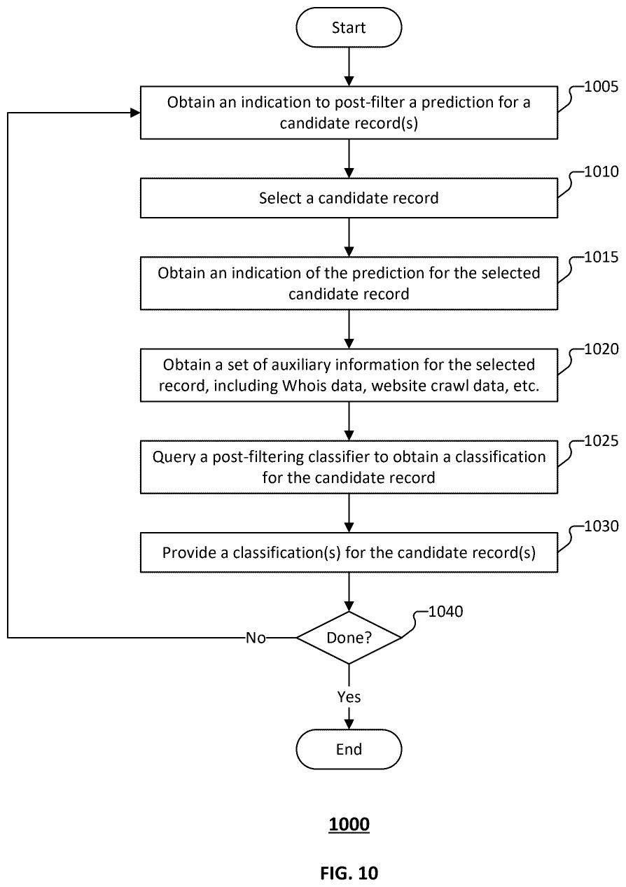

FIG. 10 is a flow diagram of a method for performing a post-filtering for classifying a candidate record according to various embodiments. In some embodiments, process 1000 is implemented at least in part by system 100 of FIG. 1, system 300 of FIG. 3, and/or system 500 of FIG. 5. Process 1000 may be implemented by a system providing security service to an inline security entity, such as to a firewall (e.g., a next generation firewall).

In some implementations, process 1000 may be implemented by one or more servers, such as in connection with providing a service to a network (e.g., a security entity and/or a network endpoint such as a client device). In some implementations, process 1000 may be implemented by a security entity (e.g., a firewall) such as in connection with enforcing a security policy with respect to DNS traffic or other traffic from/to domains across a network or in/out of the network. In some implementations, process 1000 may be implemented by a client device such as a laptop, a smartphone, a personal computer, etc., such as in connection with executing or opening a file such as an email attachment.

At 1005, the system obtains an indication to post-filter a predicted a candidate record(s). For example, process 1105 may be invoked by process 700 (e.g., at 730), process 800 (e.g., at 830), or by process 900 (e.g., at 945). At 1010, the system selects a candidate record. At 1015, the system obtains an indication of the prediction for the selected candidate record. At 1020, the system obtains a set of auxiliary information for the selected record. In some embodiments, the set of auxiliary information comprises WHOIS data for the selected record, website crawl data obtained by crawling the website for the selected record. Additionally, the set of auxiliary information may include other types of information pertaining to the selected record. At 1025, the system queries a post-filtering classifier to obtain a classification for the candidate record. The post-filtering classifier may be a machine learning-based classifier, a rule-based classifier, a heuristics-based classifier, or the like, or some combination of the foregoing. As an example, the post-filtering classifier can generate the classification based on determining a likelihood that the record is a DNS hijacking record and comparing the likelihood to a predefined maliciousness threshold, and determining the domain to be DNS hijacked if the predicted likelihood is greater than the predefined maliciousness threshold. As another example, the post filtering classifier can generate the classification based at least in determining that the auxiliary information satisfies one or more rules or heuristics. At 1035, the system provides the classification for the candidate record(s). At 1040, a determination is made as to whether process 1000 is complete. In some embodiments, process 1000 is determined to be complete in response to a determination that no further records are to be analyzed (e.g., no further candidate records are to be identified, or no further records are to be evaluated to identify whether they are candidate records), no further resource records are obtained, no further classifications are to be generated for candidate records, no further traffic is to be classified, an administrator indicates that process 1000 is to be paused or stopped, etc. In response to a determination that process 1000 is complete, process 1000 ends. In response to a determination that process 1000 is not complete, process 1000 returns to 1005.

According to various embodiments, the security appliance can modify fields in the DNS response to improve customer protection. One example is to modify the time-to-live (TTL) field in a DNS response. By setting the TTL to approximately equal the (maybe slightly larger) processing time of the real-time detection pipeline, customer devices are forced to query for a new record for the domain after TTL expiration. When the customer's device sends out a new query and if the same DNS response with the same hijacking record is received, then the system can now block the DNS response thus decreasing the time the customer is exposed to the DNS hijacking attack.

Although examples described herein in connection with processes 600-1000 of FIGS. 6-10 are described in connection with process one or more records and then looping back, according to various embodiments, these processes can be started as separate processes that are run in parallel to handle traffic as it comes in (e.g., is intercepted). As an example, prefiltering and batching (separate processes on separate machines) can be handled by one process each, that is continuously running accepting records, and outputting results (each could be a loop). As another example, for real-time detection, a separate process can be started asynchronously for each batch to be processed.

Various examples of embodiments described herein are described in connection with flow diagrams. Although the examples may include certain steps performed in a particular order, according to various embodiments, various steps may be performed in various orders and/or various steps may be combined into a single step or in parallel.

Although the foregoing embodiments have been described in some detail for purposes of clarity of understanding, the invention is not limited to the details provided. There are many alternative ways of implementing the invention. The disclosed embodiments are illustrative and not restrictive.

1. A system, comprising:
one or more processors configured to:
filter a set of DNS records in real-time to filter out DNS records determined not to be associated with DNS hijacking and store an indication of a set of resultant filtered DNS records;
detect DNS hijacking records based at least in part on processing a batch of resultant filtered DNS records, wherein:
the set of resultant filtered DNS records are batched according to a predefined timeframe; and
the processing of the batch of resultant filtered records comprises:
determining if a particular record is a candidate record for DNS hijacking;
in response to determining that the particular record is the candidate record for DNS hijacking,
generating a set of features for the candidate record for DNS hijacking; and
determining whether the candidate record is a DNS hijacking record based at least in part on querying a classifier using the set of features; and
perform an active measure in response to detecting the DNS hijacking records; and
a memory coupled to the one or more processors and configured to provide the one or more processors with instructions.

2. The system of claim 1, wherein the classifier is a machine learning model.

3. The system of claim 1, wherein the active measure is performed in response to determining that the candidate record is a result of a DNS hijacking attack comprises:
applying a security policy based on a classification of the candidate record as being a result of a DNS hijacking attack.

4. The system of claim 3, wherein applying the security policy comprises:
blocking a DNS response that comprises the DNS hijacking record.

5. The system of claim 1, wherein filtering the set of DNS records in real-time filters out at least ninety-five percent (95%) of collected DNS records.

6. The system of claim 1, wherein the set of DNS records are filtered based at least in part on one or more predetermined thresholds.

7. The system of claim 1, wherein filtering the set of DNS records in real time comprises determining in real-time whether one or more of the set of DNS records are comprised in a predefined allow list of records and domains.

8. The system of claim 7, wherein the predefined allow list of records and domains is determined offline based at least in part on one or more of (i) an age of a particular record, and (ii) a number of times a record has been observed in traffic across one or more particular networks.

9. The system of claim 1, wherein a filtering of a particular DNS record is based at least in part on one or more of (i) a determination of whether the particular DNS record is deemed a new record, (ii) a determination of whether the DNS record corresponds to a newly observed hostname, and (iii) a pre-candidate DNS hijacking record.

10. The system of claim 9, wherein the determination of whether the particular DNS record is deemed the new record is based at least in part on pre-computed passive DNS (pDNS) data.

11. The system of claim 1, wherein the predefined timeframe according to which the set of resultant filtered DNS records are batched is less than or equal to 1 minute.

12. The system of claim 1, wherein the set of resultant filtered DNS records comprise DNS records that are not filtered out based on the filtering of the set of DNS records in real-time.

13. The system of claim 12, wherein the classifier is a machine learning model that is trained using a fewer number of features than an offline machine learning model used to perform offline detection of DNS hijacking records.

14. The system of claim 1, wherein a determination of whether the particular record is a DNS hijacking record is performed within ten minutes of the particular record being obtained based on an interception of network traffic.

15. The system of claim 1, wherein a determination of whether the particular record is a DNS hijacking record is performed within 12 hours of the particular record being obtained based on an interception of network traffic.

16. The system of claim 1, wherein a set of intermediate values are precalculated offline and used to in connection with calculating a set of features used by the classifier in connection with classifying the candidate record.

17. The system of claim 16, wherein the subset of data that is pre-computed offline comprises a feature determined based at least in part on historical information for a corresponding domain.

18. The system of claim 1, wherein a subset of passive DNS (pDNS) data used in connection with determining whether the candidate record is a DNS hijacking record is pre-computed offline.

19. The system of claim 1, wherein determining whether the candidate record is a DNS hijacking record comprises:
in response to the classifier predicting that the candidate record is a DNS hijacking record,
obtaining additional information for the candidate record based at least in part on performing one or more of (a) a web crawling of a corresponding domain, and (b) a crawling of a corresponding WHOIS record; and
determining whether the candidate record is a DNS hijacking record based at least in part on results from one or more of the web crawling or the crawling of the corresponding WHOIS record.

20. The system of claim 23, wherein the web-crawling of the corresponding domain comprises:
web crawling a first page corresponding to a first IP address for the candidate record;
web crawling a second page corresponding to a first benign IP address immediately preceding the first IP address; and
web crawling a third page corresponding to a second benign IP address preceding the first benign IP address.

21. The system of claim 1, wherein determining whether the candidate record is a DNS hijacking record comprises:
in response to the classifier predicting that the candidate record is a DNS hijacking record,
performing a post filtering to remove detections expected to be false positives.

22. The system of claim 1, wherein performing the active measure comprises blocking the DNS hijacking records in real-time.

23. The system of claim 1, wherein the one or more processors are further configured to:
modify one or more DNS response fields for DNS records in the set of DNS records.

24. The system of claim 1, wherein the one or more DNS response fields that are modified comprise a time-to live field, and a value in the time-to-live field is set to be equal to a real-time DNS record classification processing time.

25. A method, comprising:
filtering a set of DNS records in real-time to filter out DNS records determined not to be associated with DNS hijacking and store an indication of a set of resultant filtered DNS records;
detect DNS hijacking records based at least in part on processing a batch of resultant filtered DNS records, wherein:
the set of resultant filtered DNS records are batched according to a predefined timeframe; and
the processing of the batch of resultant filtered records comprises:
determining if a particular record is a candidate record for DNS hijacking;
in response to determining that the particular record is the candidate record for DNS hijacking,
generating a set of features for the candidate record for DNS hijacking; and
determining whether the candidate record is a DNS hijacking record based at least in part on querying a classifier using the set of features; and
performing an active measure in response to detecting the DNS hijacking records.

26. A computer program product embodied in a non-transitory computer readable medium and comprising computer instructions for:
filtering a set of DNS records in real-time to filter out DNS records determined not to be associated with DNS hijacking and store an indication of a set of resultant filtered DNS records;
detect DNS hijacking records based at least in part on processing a batch of resultant filtered DNS records, wherein:
the set of resultant filtered DNS records are batched according to a predefined timeframe; and
the processing of the batch of resultant filtered records comprises:
determining if a particular record is a candidate record for DNS hijacking;
in response to determining that the particular record is the candidate record for DNS hijacking,
generating a set of features for the candidate record for DNS hijacking; and
determining whether the candidate record is a DNS hijacking record based at least in part on querying a classifier using the set of features; and
performing an active measure in response to detecting the DNS hijacking records.
